(19) United States
(12) Patent Application Publication
(10) Pub. No.: US 2026/0341029 A1
(43) Pub. Date: Oct. 29, 2026

(54) EDGE-BASED COMPUTER VISION PROCESSING SYSTEMS AND METHODS

(71) Applicant: Lantronix, Inc., Irvine, CA (US)

(72) Inventor: Ashish Syal, New Westminster (CA)

(21) Appl. No.: 19/707,212

(22) Filed: Jun. 12, 2026

Related U.S. Application Data
(63) Continuation of application No. PCT/US2026/012776, filed on Jan. 27, 2026.
(60) Provisional application No. 63/750,739, filed on Jan. 28, 2025.

(51) Int. Cl. G06V 20/52

(52) U.S. Cl. CPC G06V 20/52

(57) ABSTRACT

Devices, systems, methods, and processes for capturing, processing, and storing edge data are described herein. A network deployment may have a variety of devices, some that exist in a centralized location of the network, while others exist on the edge of a network. Video data captured by edge devices traditionally has to be sent to a centralized device for processing, which eats up bandwidth and processing resources. In many embodiments described herein, edge devices can process edge data, such as video data at the edge to determine context and compress the data effectively to save bandwidth and other resources. This can be done by utilizing the edge data as input into one or more computer vision models, which can be formatted to input into one or more large language models or the like to generate context. This context can be utilized to determine what data is important or not important.

### CROSS REFERENCE TO RELATED APPLICATIONS

This application is a continuation of International Patent Application No. PCT/US2026/012776 filed Jan. 27, 2026 and entitled “EDGE-BASED COMPUTER VISION PROCESSING SYSTEMS AND METHODS,” which claims priority to and the benefit of U.S. Provisional Patent Application No. 63/750,739 filed Jan. 28, 2025 and entitled “EDGE-BASED COMPUTER VISION PROCESSING,” all of which are incorporated herein by reference in their entirety.

### TECHNICAL FIELD

The present disclosure relates to image processing. More particularly, the present disclosure relates to effectively processing image data across one or more edge devices.

### BACKGROUND

Computer vision processes play a vital role in extracting meaningful information from digital images or videos, encompassing various tasks such as object detection, image classification, and segmentation. In the context of IoT networks, deploying computer vision involves devices both at the edge and within a centralized data network. At the edge of the network, where IoT devices equipped with cameras capture image data, data is sent to a centralized server for processing. This processing might include tasks like noise reduction, resizing, or compression to optimize the data before transmission.

In the centralized network, additional leveraging of heavier-duty algorithms such as deep learning models for complex object detection, recognition, or scene understanding can occur. The centralized network also serves as the hub for aggregating data from multiple edge devices, allowing for a comprehensive analysis of the overall environment. This aggregated data enables higher-level decision-making processes based on the insights derived from computer vision processing.

However, deploying computer vision in IoT networks comes with its own set of challenges and considerations. Firstly, latency can be a critical issue, especially for real-time applications. Bandwidth constraints also pose challenges, as transmitting large volumes of image data from edge devices to the centralized network can strain network resources. Moreover, security and privacy concerns are paramount in IoT environments, particularly when dealing with sensitive image data. Additionally, scalability and resource constraints must be addressed to accommodate the growing number of edge devices and increasing computational demands.

### SUMMARY

Systems and methods for effectively processing image data across one or more edge devices in accordance with embodiments of the disclosure are described herein. In some embodiments a device includes a processor, a network interface controller configured to provide access to a network, and a memory communicatively coupled to the processor, wherein the memory includes an edge processing logic. The logic is configured to receive edge data from a plurality of network devices, process the edge data, extract one or more contextual features from the edge data, detect at least one behavior based on the one or more contextual features, and generate an alert based on the at least one behavior.

In some embodiments, the at least one behavior is suspicious behavior.

In some embodiments, the plurality of network devices includes at least a network-connected video camera.

In some embodiments, the edge data includes at least video data.

In some embodiments, the edge data includes at least metadata.

In some embodiments, processing the edge data includes at least inputting the edge data into one or more machine learning processes.

In some embodiments, the one or more machine learning processes includes at least a computer vision model.

In some embodiments, an output of the computer vision model is utilized as an input on a large language model.

In some embodiments, the output of the large language model is utilized to extract the one or more contextual features.

In some embodiments, the edge processing logic is further configured to change a state of a system based on the one or more detected behaviors.

In some embodiments, the alert is generated based on the change in state of the system.

In some embodiments, the device exists within a networked system of devices including centralized devices and edge devices.

In some embodiments, the device is an edge device.

In some embodiments, the edge processing logic is further configured to store the processed edge data.

In some embodiments, the edge processing logic is further configured to compress the processed edge data prior to storage.

In some embodiments, storing the processed edge data includes transmitting the processed edge data to a centralized device.

In some embodiments, compression of the processed edge data is based on the at least one detected behavior.

In some embodiments, a device includes a processor, a network interface controller configured to provide access to a network, and a memory communicatively coupled to the processor, wherein the memory includes an edge processing logic. The logic is configured to receive edge data from a plurality of network devices, process the edge data, extract one or more contextual features from the edge data, detect at least one behavior based on the one or more contextual features, compress the processed edge data based on the at least one behavior, and store the processed edge data, wherein the device exists within a networked system of devices including centralized devices and edge devices, and the device is an edge device.

In some embodiments, the processed edge data is stored on a centralized device.

In some embodiments, a method, includes receiving edge data from a plurality of network devices, processing the edge data, extracting one or more contextual features from the edge data, detecting at least one behavior based on the one or more contextual features, compressing the processed edge data based on the at least one behavior, and storing the processed edge data.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a conceptual illustration of a video data processing system in accordance with various embodiments of the disclosure;

FIG. 2 is a conceptual system architecture for edge video processing in accordance with various embodiments of the disclosure;

FIG. 3 is a conceptual system block chart for edge video processing in accordance with various embodiments of the disclosure;

FIG. 4A is a conceptual illustration of a sample image within one or more sets of image data in accordance with an embodiment of the disclosure;

FIG. 4B is a conceptual illustration of a sample image within one or more sets of image data processed to recognize a plurality of subjects in accordance with an embodiment of the disclosure;

FIG. 5 is a conceptual matrix of behavior detection within video data processed with edge devices in accordance with various embodiments of the disclosure;

FIG. 6 is a flowchart depicting a process for processing edge data for behaviors in accordance with various embodiments of the disclosure;

FIG. 7 is a flowchart depicting a process for determining alert states from edge data in accordance with various embodiments of the disclosure;

FIG. 8 is a flowchart depicting a process for adjusting a state based on an event classification in accordance with various embodiments of the disclosure;

FIG. 9 is a flowchart depicting a process for storing compressed edge data in accordance with various embodiments of the disclosure; and

FIG. 10 is a device suitable for utilizing an edge processing logic in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are discussed herein that allow for the capturing of edge data, such as video data and processing the edge data for use in responding to queries associated with the edge data. In various embodiments, a network deployment may have various devices situated across a large area. Network devices on the edge can traditionally need to send excess data to centralized devices for processing, such as responding to queries. In a number of embodiments, the edge devices can process the edge data into numerous structures that allow for the processing of queries on the edge devices. In more embodiments, the edge data can be processed such that less data is required to be transferred to centralized devices. This can improve the function of the network devices by providing responses to queries in less time and reduce the amount of data transferred across the network, increasing overall network bandwidth.

Capturing edge data and processing it on edge devices before sending it to centralized devices on the network is a strategy adopted in various embodiments, particularly those requiring real-time or near-real-time analysis. This approach offers several advantages, including reduced latency, decreased network bandwidth usage, and enhanced privacy by minimizing data transmission. In this context, edge devices such as IoT sensors or cameras capture raw data, such as video streams, directly at the source. These devices are equipped with computational capabilities to perform initial processing tasks locally. For example, a camera equipped with a computer vision model can analyze the video feed in real-time to detect objects, recognize faces, or identify events of interest. This initial processing on the edge device filters and prioritizes the data, transmitting only relevant or actionable information to centralized devices on the network.

By integrating both computer vision models and LLMs into the edge processing pipeline, edge devices can perform increasingly sophisticated analyses locally, reducing reliance on centralized resources and mitigating latency issues associated with transmitting large volumes of raw data over the network. Moreover, this distributed processing architecture enhances scalability and resilience, as edge devices can operate autonomously even in scenarios where network connectivity is limited or intermittent. Overall, capturing and processing edge data on edge devices before sending it to centralized devices represents a powerful paradigm for efficient, responsive, and privacy-aware data processing in distributed environments.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.” Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

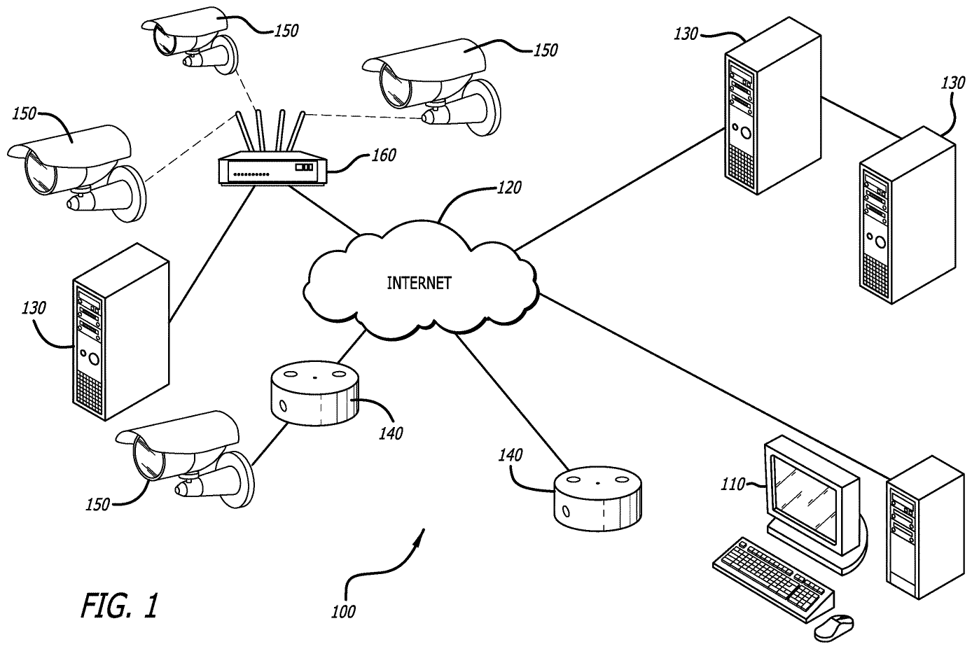

Referring to FIG. 1, a conceptual illustration of a video data processing system 100 in accordance with various embodiments of the disclosure is shown. In many embodiments, it may be desired to monitor one or more visual areas by installing cameras 150 within those areas. The cameras 150 can generate a plurality of video data (i.e., “video content”) that can be processed. In some embodiments, the video data can be video data captured on the edge of a network and processed as edge data. In a number of embodiments, the processing of the video data will be configured to determine if one or more specific objects are within the monitored visual areas. In a more embodiments, this detection may be presented as an inference map image from an object detection neural network or computer vision model which can generate data such as a segmentation or panoptic map. These maps can be utilized as a classification as to whether a specific object is present within the image data or not. These maps can be generated as an output from a neural network such as, but not limited to, a convolutional neural network (CNN). By way of example, and not limitation, video data processing can be established to detect the presence of one or more pedestrians within the monitored visual areas or tracking various shoppers within a retail environment, etc. It will be understood by those skilled in the art that the video data processing may be performed by processors internal to cameras 150 or elsewhere in the system 100, within devices on the edge of the system 100 or in some combination thereof. The video data processing may be implemented in software operating in conventional processors (e.g., CPU, MPU, GPU, RISC, etc.), and/or software operating in specifically purposed processors optimized to implement neural networks—or some combination thereof.

Often, traditional methods, the video data processing system 100 will process the video data within a centralized video processing server 110. However, embodiments described herein can offload various processing tasks to other devices such as, but not limited to servers 130 which may be specialized or edge type servers, or internal to the cameras 150 (themselves edge network devices). A video processing server 110 can be connected to a network 120 such as the Internet as depicted in FIG. 1. A plurality of cameras 150 can also be attached to the network 120 such that they are communicatively coupled to the video processing server 110 which comprises one or more processors for processing video data like, for example, CPUs, MPUs, GPUs, etc. Although the embodiment of FIG. 1 depicts cameras 150, it will be understood by those skilled in the art that any video data capture device may be utilized as required by the desired application.

The cameras 150 can be wired directly to the network 120 or may be wirelessly connected via one or more wireless access points 160. In this way, a variety of potential deployment arrangements may be realized to properly cover the desired areas for surveillance. In theory, there is no limit to the number of deployed cameras 150 or other video data capture devices that may be communicatively coupled with the video processing server 110. The limitations experienced may relate to the available bandwidth of the network 120 and computational resources of the video processing server 110 or other supplemental server 130. As discussed below, many embodiments of the video data processing system 100 can handle the bulk of the processing locally by cameras 150 or other edge network devices 140 to minimize network traffic and reduce the need for centralized computing resources like video processing server 110 and servers 130.

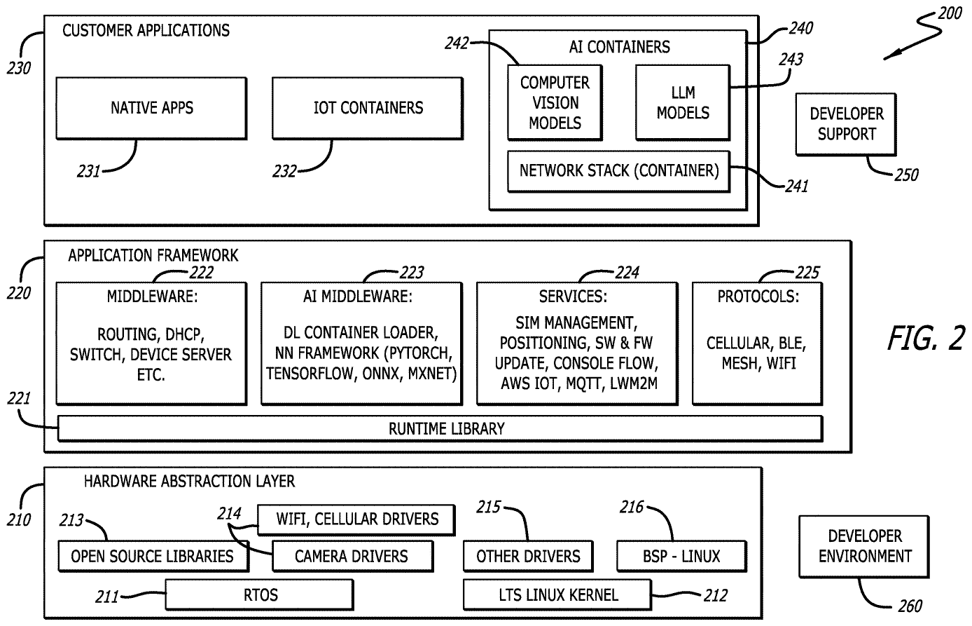

Although a specific embodiment for a video data processing system suitable for carrying out the various steps, processes, methods, and operations described herein is discussed with respect to FIG. 1, any of a variety of systems and/or processes may be utilized in accordance with embodiments of the disclosure. For example, the cameras 150 may be deployed over many different environments. The elements depicted in FIG. 1 may also be interchangeable with other elements of FIGS. 2-10 as required to realize a particularly desired embodiment.

Referring to FIG. 2, a conceptual system architecture 200 for edge video processing in accordance with various embodiments of the disclosure is shown. In an edge artificial intelligence (AI) network architecture, a hardware abstraction layer (HAL) 210 serves as an intermediary between the AI algorithms and the underlying hardware components. HAL 210 abstracts the hardware complexities and provides a unified interface for interacting with various hardware devices, enabling seamless integration and portability of AI applications across different hardware platforms. At the edge, where computational resources are often limited and heterogeneous, HAL 210 plays a crucial role in optimizing resource utilization and ensuring efficient execution of AI workloads.

The HAL 210 abstracts the specific hardware details, such as processor architectures, memory configurations, and communication interfaces, into a standardized set of interfaces and APIs (Application Programming Interfaces). This allows AI developers to write platform-independent code that can run on different hardware platforms without modification. For example, instead of directly interfacing with the hardware accelerators or peripheral devices, AI algorithms interact with the HAL 210 through standardized APIs, which handle the low-level hardware interactions transparently.

Furthermore, HAL 210 provides services for resource management, scheduling, and optimization to maximize the performance and efficiency of AI workloads on edge devices. It dynamically allocates computational resources based on the workload requirements and device capabilities, ensuring that AI tasks are executed optimally while minimizing resource contention and latency. Additionally, HAL 210 abstracts the communication between AI modules and external sensors or actuators, enabling seamless integration of AI capabilities with IoT devices and other edge peripherals.

Within the hardware abstraction layer (HAL 210) of an edge artificial intelligence (AI) network architecture, a Real-Time Operating System (RTOS) 211 plays a crucial role in orchestrating the execution of tasks and managing resources on the underlying hardware devices. The RTOS 211 serves as the core software layer that ensures the timely and deterministic execution of AI algorithms, sensor data processing, and control tasks in real-time or near-real-time scenarios. Task management is a primary function of the RTOS 211, as it oversees the scheduling and execution of various tasks associated with AI inference, data acquisition, preprocessing, and communication. By prioritizing tasks based on their urgency and timing constraints, the RTOS 211 guarantees that critical operations, such as real-time control or event handling, are completed within specified deadlines, maintaining system responsiveness and stability.

Resource allocation is another key aspect managed by the RTOS 211 within the HAL 210. It dynamically assigns computational resources, including CPU time, memory, and I/O bandwidth, to different tasks based on their priority levels and resource requirements. This ensures optimal resource utilization and performance, even in resource-constrained edge computing environments. Moreover, the RTOS 211 handles interrupts generated by peripheral devices, such as sensors or actuators, promptly and deterministically. By prioritizing and servicing interrupts based on their criticality, the RTOS 211 ensures that time-sensitive events, such as sensor data acquisition or control signals, are processed without delay, enabling timely responses to external stimuli.

In addition to task management and resource allocation, the RTOS 211 facilitates communication and synchronization between different tasks and hardware components within the edge device. It provides mechanisms for inter-task communication, such as message queues, semaphores, and shared memory, enabling seamless data exchange and coordination between concurrent tasks. This allows AI algorithms to interact with sensor data, control actuators, and communicate with other edge devices in a synchronized manner, supporting complex edge AI applications. Furthermore, the RTOS 211 incorporates features for fault tolerance and reliability, ensuring that the system can detect and recover from errors or faults gracefully. This capability is essential for mission-critical edge AI applications where reliability and uptime are paramount, safeguarding against system failures and ensuring uninterrupted operation in cHAL 210 lenging environments. Overall, the integration of an RTOS 211 into the HAL 210 of an edge AI network architecture provides a robust and efficient platform for deploying real-time AI applications in diverse edge computing scenarios.

The utilization of a Long-Term Support (LTS) Linux Kernel 212 within the hardware abstraction layer (HAL 210) of an edge artificial intelligence (AI) network architecture offers several advantages for managing hardware resources and facilitating seamless integration of AI algorithms. The LTS Linux Kernel 212 serves as the underlying operating system layer that interacts directly with the hardware components of the edge devices, providing essential services such as device drivers 214 (shown as “wifi, cellular drivers”, and “camera drivers”), memory management, and process scheduling. Within the HAL 210, the LTS Linux Kernel 212 abstracts the hardware complexities and provides a standardized interface for higher-level software components, including AI algorithms and application framework 220s.

One of the key benefits of utilizing an LTS Linux Kernel 212 in the HAL 210 is its broad support for a wide range of hardware platforms and devices commonly found in edge computing environments. The LTS Linux Kernel 212 includes a comprehensive set of device drivers 214 and support for various hardware interfaces, enabling edge devices to seamlessly interface with sensors, cameras, accelerometers, and other peripheral devices. This ensures compatibility and interoperability across different hardware configurations, simplifying the development and deployment of edge AI applications.

Moreover, the LTS Linux Kernel 212 offers robust memory management and process scheduling capabilities, which are essential for efficient resource utilization and multitasking in edge computing scenarios. The kernel manages memory allocation, virtual memory mapping, and process execution, ensuring that AI algorithms and other tasks run smoothly without resource contention or system instability. Additionally, the kernel provides mechanisms for power management and system optimization, enabling edge devices to conserve energy and extend battery life, which is critical for battery-powered or resource-constrained edge devices.

Furthermore, the LTS Linux Kernel 212 supports real-time capabilities through features such as the PREEMPT_RT patchset, which enhances the kernel's responsiveness and determinism for real-time applications. This is particularly beneficial for edge AI applications that require low-latency and predictable performance, such as control systems, robotics, and industrial automation. By leveraging the real-time capabilities of the LTS Linux Kernel 212, the HAL 210 can ensure that critical AI tasks, sensor data processing, and control algorithms are executed with precise timing and reliability, meeting the stringent requirements of real-time edge computing applications.

Open-source libraries 213 play a crucial role in enhancing the functionality and flexibility of a hardware abstraction layer (HAL 210) within an edge artificial intelligence (AI) network architecture. These libraries provide pre-built software components, modules, and algorithms that can be leveraged to streamline the development and implementation of the HAL 210, reducing time-to-market and development costs. In the context of the HAL 210, open-source libraries 213 can be utilized in various ways to facilitate hardware interaction, AI algorithm execution, and overall system management.

One common use of open-source libraries 213 in the HAL 210 is for device drivers 214 and hardware abstraction. These libraries provide standardized interfaces and APIs for interacting with different hardware components, including sensors, cameras, communication interfaces, and peripherals. By abstracting the hardware details and providing a unified interface, these libraries simplify the integration of diverse hardware devices into the edge computing platform. Developers can use these libraries to access and control hardware resources without needing to understand the intricacies of low-level hardware programming, enabling rapid prototyping and deployment of edge AI applications.

Furthermore, open-source libraries 213 offer a wealth of AI algorithms and machine learning models that can be integrated into the HAL 210 to enhance its capabilities. These libraries include popular frameworks such as TensorFlow, PyTorch, and OpenCV, which provide a wide range of algorithms for tasks such as object detection, image classification, natural language processing, and anomaly detection. By leveraging these pre-built algorithms, developers can quickly implement AI-driven functionalities in the HAL 210, enabling edge devices to perform advanced analytics and decision-making tasks autonomously.

Moreover, open-source libraries 213 can be used for system management and optimization within the HAL 210. These libraries provide tools and utilities for tasks such as performance monitoring, resource allocation, power management, and security enforcement. For example, libraries like Apache Kafka or MQTT can be used for efficient data streaming and communication between edge devices and cloud services. Similarly, libraries like Docker or Kubernetes can be used for containerization and orchestration of edge applications, ensuring scalability, reliability, and portability of the HAL 210 across different deployment environments.

A BSP (Board Support Package) for Linux 216 serves as a foundational component within the hardware abstraction layer (HAL 210) of an edge artificial intelligence (AI) network architecture, providing essential software components and drivers to enable Linux to run on specific hardware platforms. BSP-Linux 216 packages typically include device drivers 214, kernel configurations, boot loaders, and other software components tailored to a particular hardware platform. In the context of the HAL 210, BSP-Linux facilitates seamless interaction between the underlying hardware devices and the higher-level software components, including AI algorithms and system management utilities.

One of the primary functions of BSP-Linux within the HAL 210 is to provide device drivers 214 and hardware abstraction for the edge computing platform. These device drivers 214 enable Linux to interface with various hardware components, such as sensors, cameras, communication interfaces, and peripheral devices, by abstracting the hardware details and providing a standardized interface. By incorporating BSP-Linux into the HAL 210, developers can ensure compatibility and interoperability across different hardware configurations, simplifying the integration of diverse hardware devices into the edge computing platform.

Moreover, BSP-Linux contributes to system initialization and configuration within the HAL 210, ensuring that the hardware devices are initialized and configured correctly during the boot process. This involves tasks such as configuring kernel parameters, initializing memory, setting up interrupt handlers, and loading necessary firmware or device tree overlays. By handling these initialization tasks, BSP-Linux streamlines the boot process and ensures that the hardware devices are ready for operation when the system is booted up, reducing startup time and improving system reliability.

Additionally, BSP-Linux plays a crucial role in managing power consumption and optimizing system performance within the HAL 210. BSP-Linux includes power management features, such as CPU frequency scaling, device power states management, and system sleep modes, to minimize energy consumption and extend battery life in resource-constrained edge devices. Moreover, BSP-Linux incorporates performance optimization techniques, such as kernel configuration tuning, memory optimization, and I/O scheduling, to maximize the efficiency and responsiveness of the edge computing platform.

Furthermore, BSP-Linux provides support for real-time capabilities through features such as the PREEMPT_RT patchset, which enhances the Linux Kernel 212's responsiveness and determinism for real-time applications. This is particularly beneficial for edge AI applications that require low-latency and predictable performance, such as control systems, robotics, and industrial automation. By leveraging BSP-Linux, the HAL 210 can ensure that critical AI tasks, sensor data processing, and control algorithms are executed with precise timing and reliability, meeting the stringent requirements of real-time edge computing applications.

Drivers 215, including those for Wi-Fi, cellular, camera, and other peripherals, are essential components utilized within the hardware abstraction layer (HAL 210) of an edge artificial intelligence (AI) network architecture. These drivers 215 serve as intermediaries between the higher-level software components, such as AI algorithms and system management utilities, and the underlying hardware devices. In the context of the HAL 210, drivers 215 play a crucial role in abstracting the hardware details and providing a standardized interface for interacting with various hardware components, enabling seamless integration and interoperability across different hardware platforms.

For example, Wi-Fi and cellular drivers 214 enable edge devices to establish wireless connectivity and communicate with remote servers, cloud platforms, or other edge devices. These drivers 215 handle tasks such as network configuration, authentication, encryption, and data transmission, allowing edge devices to access external data sources, upload telemetry data, or receive software updates over the network. By abstracting the complexities of wireless communication protocols and hardware interfaces, Wi-Fi and cellular drivers 214 simplify the integration of wireless connectivity into the edge computing platform, enabling flexible and scalable deployment of edge AI applications.

Similarly, camera drivers 214 facilitate the acquisition and processing of visual data from cameras or imaging sensors deployed on edge devices. These drivers handle tasks such as camera initialization, configuration, frame capture, and image processing, enabling edge devices to capture images or video streams for analysis by AI algorithms. Camera drivers abstract the hardware-specific details of camera interfaces, such as USB, MIPI CSI, or Ethernet, providing a unified interface for accessing camera data regardless of the underlying hardware platform. This enables developers to seamlessly integrate camera functionality into edge AI applications without needing to understand the intricacies of camera hardware or communication protocols.

Additionally, other drivers 215, such as those for sensors, actuators, storage devices, or communication interfaces, are utilized within the HAL 210 to enable interaction with various hardware peripherals and components. These drivers 215 provide standardized interfaces and APIs for accessing and controlling hardware resources, allowing edge devices to interface with sensors for environmental monitoring, control actuators for device automation, or communicate with external devices using protocols like SPI, I2C, or UART. By abstracting the hardware-specific details of peripheral devices, these drivers 215 ensure compatibility and interoperability across different hardware configurations, facilitating rapid prototyping and deployment of edge AI applications.

In the context of an edge AI network architecture, an application framework 220 plays a pivotal role in facilitating the development, deployment, and management of edge AI applications. An application framework 220 provides a comprehensive set of tools, libraries, and APIs that streamline the development process and abstract the complexities of building and running AI-driven applications at the edge. These frameworks offer standardized interfaces for tasks such as data preprocessing, model training, inference execution, and result visualization, enabling developers to focus on application logic and functionality without needing to delve into low-level implementation details.

One primary use of an application framework 220 within the edge AI network architecture is for AI model management and deployment. These frameworks typically include tools for model training, optimization, and conversion, allowing developers to train machine learning models using diverse datasets and algorithms. Once trained, the models can be optimized for deployment on edge devices with resource constraints, such as limited memory, processing power, or energy consumption. The framework handles tasks such as model quantization, pruning, and compression to reduce model size and complexity, ensuring efficient execution on edge devices without sacrificing performance or accuracy.

Furthermore, application framework 220s offer APIs and libraries for executing AI inference tasks on edge devices. These inference engines provide runtime environments for loading and executing pre-trained models, handling data input/output, and performing inference calculations efficiently. By leveraging these inference engines, developers can deploy AI models on edge devices and execute real-time inference tasks, such as object detection, image classification, anomaly detection, or predictive maintenance, directly on the device without relying on cloud services or external servers. This enables edge devices to make autonomous decisions and take actions based on local data, reducing latency, bandwidth consumption, and reliance on network connectivity.

Moreover, application framework 220s support edge AI application development by providing tools for data preprocessing, feature extraction, and result visualization. These tools simplify data management tasks, such as data cleaning, transformation, and augmentation, ensuring that input data is appropriately processed and formatted before being fed into AI models. Additionally, frameworks offer utilities for visualizing model outputs, analyzing inference results, and monitoring system performance, enabling developers to validate model accuracy, debug errors, and optimize application behavior iteratively. This facilitates the development of robust and reliable edge AI applications that meet the specific requirements and constraints of the edge computing environment.

Runtime libraries 221 play a crucial role within the application framework 220 discussed in the context of an edge AI network architecture, providing essential functionalities and services for executing AI-driven applications on edge devices. These libraries offer a set of pre-built software components, APIs, and runtime environments that streamline the deployment, execution, and management of AI models and applications at the edge. Within the application framework 220, runtime libraries 221 are utilized in various ways to facilitate model deployment, inference execution, and system management tasks.

One primary use of runtime libraries 221 within the application framework 220 is for model deployment and inference execution. These libraries provide runtime environments and APIs for loading, initializing, and executing pre-trained machine learning models on edge devices. By leveraging these runtime environments, developers can deploy AI models directly onto edge devices and perform real-time inference tasks, such as object detection, image classification, or anomaly detection, without relying on external servers or cloud services. The runtime libraries 221 handle tasks such as model loading, input data processing, inference calculation, and result output, ensuring efficient execution of AI models on resource-constrained edge devices.

Furthermore, runtime libraries 221 offer optimization and acceleration techniques to improve the performance and efficiency of AI inference tasks on edge devices. These libraries include optimizations for hardware acceleration, such as GPU, FPGA, or neural processing unit (NPU), to leverage specialized hardware accelerators for accelerating model inference calculations. Additionally, runtime libraries 221 may incorporate techniques such as model quantization, pruning, and compression to reduce model size and complexity, enabling efficient execution on edge devices with limited memory and processing power. By optimizing inference performance, runtime libraries 221 ensure that AI-driven applications can meet real-time performance requirements and operate effectively in edge computing environments.

Moreover, runtime libraries 221 support system management and monitoring tasks within the application framework 220. These libraries provide utilities for monitoring system performance, analyzing inference results, and logging runtime metrics, enabling developers to assess application behavior, diagnose errors, and optimize system performance iteratively. Additionally, runtime libraries 221 may include tools for managing system resources, such as memory allocation, task scheduling, and power management, to ensure efficient utilization of hardware resources and optimize energy consumption on edge devices. By providing these system management capabilities, runtime libraries 221 enable developers to build robust and reliable edge AI applications that meet the specific requirements and constraints of the edge computing environment.

Middleware 222, including routing, DHCP (Dynamic Host Configuration Protocol), switches, device servers, and other components, play a crucial role within the application framework 220 discussed in the context of an edge AI network architecture. These middleware 222 components provide essential infrastructure services and networking capabilities that enable communication, data exchange, and system management within the edge computing environment. Within the application framework 220, middleware 222 is utilized in various ways to facilitate seamless integration, connectivity, and interoperability of edge devices and applications.

Routing middleware 222, for example, is utilized to establish network routes and paths for data transmission between edge devices, cloud services, and external networks. Routing algorithms determine the most efficient path for data packets to travel based on factors such as network topology, bandwidth availability, and latency constraints, ensuring optimal data routing and delivery. By leveraging routing middleware 222, edge AI applications can communicate with remote servers, cloud platforms, or other edge devices over wired or wireless networks, enabling seamless data exchange and collaboration across distributed environments.

Similarly, DHCP middleware 222 is used to dynamically assign IP addresses and network configuration parameters to edge devices within the network. DHCP servers automate the process of IP address allocation, ensuring that each device on the network has a unique identifier and can communicate with other devices and services. By automating IP address management, DHCP middleware 222 simplifies network configuration and administration, reducing the burden on system administrators and facilitating rapid deployment and scaling of edge computing solutions.

Additionally, switches and device servers are utilized within the application framework 220 to manage network connectivity and facilitate data exchange between edge devices and external systems. Switches provide network segmentation and traffic management capabilities, enabling efficient data transmission and reducing network congestion. Device servers act as intermediaries between edge devices and external systems, providing protocol translation, data aggregation, and integration services. By utilizing switches and device servers within the application framework 220, edge AI applications can establish reliable and secure communication channels with external services, IoT devices, or cloud platforms, enabling seamless integration and interoperability across heterogeneous environments.

Moreover, other middleware 222 components, such as message brokers, data brokers, and protocol gateways, may be utilized within the application framework 220 to facilitate data exchange, event processing, and integration between different systems and protocols. Message brokers, for example, enable publish-subscribe messaging patterns, allowing edge devices and applications to exchange data asynchronously and decoupling producers from consumers. Data brokers facilitate data aggregation, filtering, and transformation, enabling edge devices to process and transmit data efficiently. Protocol gateways provide translation and interoperability between different communication protocols, enabling seamless integration of legacy systems, proprietary protocols, and modern IoT standards within the edge computing environment.

AI middleware 223, including DL (Deep Learning) containers, loaders, and neural network (NN) frameworks such as PyTorch, TensorFlow, ONNX, and MXNet, play a crucial role within the application framework 220 discussed in the context of an edge AI network architecture. These middleware 222 components provide essential tools, libraries, and runtime environments for developing, deploying, and executing AI-driven applications on edge devices. Within the application framework 220, AI middleware 223 is utilized in various ways to facilitate model deployment, inference execution, and integration with edge computing systems.

DL containers serve as portable, self-contained environments for packaging and deploying AI models and dependencies. These containers encapsulate all the necessary software components, libraries, and dependencies required to run AI applications, ensuring consistency and reproducibility across different computing environments. Within the application framework 220, DL containers are utilized to package and distribute pre-trained AI models, enabling developers to deploy models on edge devices with ease. By leveraging DL containers, developers can ensure that AI models are packaged with their dependencies and can be deployed seamlessly on diverse edge computing platforms without compatibility issues.

Loaders within the AI middleware 223 are responsible for loading and initializing pre-trained AI models into memory for inference execution. These loaders handle tasks such as model loading, input data preprocessing, and result output, ensuring that AI models are ready for inference tasks on edge devices. Within the application framework 220, loaders abstract the complexities of model loading and initialization, providing a unified interface for accessing and executing AI models across different frameworks and platforms. By leveraging loaders, developers can integrate pre-trained models into their edge AI applications efficiently, enabling real-time inference tasks without needing to implement low-level model loading logic.

Moreover, NN frameworks such as PyTorch, TensorFlow, ONNX, and MXNet provide comprehensive sets of tools, APIs, and runtime environments for developing and executing AI models on edge devices. These frameworks offer support for various neural network architectures, optimization techniques, and hardware accelerators, enabling developers to build and deploy AI models tailored to specific edge computing requirements. Within the application framework 220, NN frameworks are utilized to train, optimize, and deploy AI models, as well as to perform real-time inference tasks on edge devices. By leveraging NN frameworks, developers can leverage state-of-the-art machine learning algorithms and techniques to build robust, efficient, and scalable edge AI applications.

Additionally, AI middleware 223 facilitates model interoperability and portability through standardized formats such as ONNX (Open Neural Network Exchange), enabling seamless integration and interoperability between different AI frameworks and platforms. ONNX provides a common representation for trained models, allowing models trained in one framework to be exported, imported, and executed in another framework without conversion or compatibility issues. Within the application framework 220, ONNX enables developers to leverage the strengths of different AI frameworks and tools, ensuring flexibility and interoperability in model development and deployment.

Services 224, including SIM management, positioning, software and firmware updates, consoleflow, AWS IoT, MQTT, and LWM2M, play essential roles within the application framework 220 discussed in the context of an edge AI network architecture. These services 224 provide critical functionalities and capabilities that enable edge devices to connect, communicate, and interact with external systems, cloud platforms, and IoT networks. Within the application framework 220, services 224 are utilized in various ways to facilitate device management, data exchange, and system integration tasks.

SIM management services 224 enable the provisioning, activation, and management of SIM cards and cellular connectivity for edge devices. These services 224 handle tasks such as SIM card registration, subscription management, data usage monitoring, and roaming support, ensuring seamless connectivity and reliable communication over cellular networks. Within the application framework 220, SIM management services 224 enable edge devices to establish and maintain cellular connections, enabling data transmission, remote monitoring, and control of edge devices in diverse deployment environments.

Positioning services 224 provide accurate location information and geospatial data for edge devices, enabling applications such as asset tracking, fleet management, and geofencing. These services 224 utilize GPS, Wi-Fi, cellular triangulation, or other positioning technologies to determine the geographical coordinates and movements of edge devices. Within the application framework 220, positioning services 224 enable developers to track the location of edge devices in real-time, monitor their movements, and trigger location-based actions or alerts based on predefined rules and geofences.

Software and firmware update services 224 facilitate the remote deployment and management of software updates, patches, and firmware upgrades for edge devices. These services 224 handle tasks such as version management, dependency resolution, deployment scheduling, and rollback procedures, ensuring seamless and secure updates of software and firmware on edge devices. Within the application framework 220, update services 224 enable developers to deploy bug fixes, security patches, and new features to edge devices over-the-air, without requiring manual intervention or physical access to the devices.

Consoleflow, AWS IoT, MQTT, and LWM2M are communication and messaging protocols/services 224 used within the application framework 220 to enable seamless data exchange, device management, and integration with external systems and cloud platforms. Consoleflow provides a centralized dashboard and management console for monitoring, configuring, and managing edge devices and applications. AWS IoT offers a suite of services 224 for connecting, managing, and securing IoT devices, enabling seamless integration with AWS cloud services 224 and infrastructure. MQTT (Message Queuing Telemetry Transport) is a lightweight messaging protocol used for publish-subscribe messaging patterns, facilitating asynchronous communication between edge devices, cloud services 224, and other systems. LWM2M (Lightweight M2M) is a protocol for managing and provisioning IoT devices, enabling remote configuration, firmware updates, and device management functionalities.

Within the application framework 220, these services 224 enable edge devices to communicate with cloud platforms, exchange data with external systems, and perform remote management and monitoring tasks efficiently. By leveraging services 224 such as SIM management, positioning, software updates, and communication protocols like Consoleflow, AWS IoT, MQTT, and LWM2M, developers can build robust, scalable, and interconnected edge AI applications that leverage the capabilities of edge computing and IoT technologies to enable real-time insights, decision-making, and automation in diverse deployment scenarios.

Protocols 225 such as cellular, Bluetooth Low Energy (BLE), mesh networking, and Wi-Fi play integral roles within the application framework 220 discussed in the context of an edge AI network architecture. These protocols 225 provide the communication standards and technologies that enable edge devices to connect, exchange data, and interact with each other, as well as with external systems and cloud platforms. Within the application framework 220, protocols 225 are utilized in various ways to establish communication channels, facilitate data exchange, and enable seamless integration with diverse networking environments.

Cellular protocols 225, such as LTE (Long-Term Evolution) and 5G, are widely used for providing wide-area wireless connectivity to edge devices, enabling communication over cellular networks. Cellular protocols 225 offer high-speed data transmission, wide coverage, and reliable connectivity, making them suitable for applications that require mobility or remote access. Within the application framework 220, cellular protocols 225 enable edge devices to establish internet connectivity, transmit data to cloud platforms, and receive commands or updates remotely, facilitating real-time monitoring, control, and management of edge devices in diverse deployment scenarios.

Bluetooth Low Energy (BLE) is a short-range wireless communication protocol commonly used for connecting edge devices to smartphones, wearables, and other nearby devices. BLE enables low-power, energy-efficient communication between devices, making it suitable for applications such as proximity sensing, indoor navigation, and personal area networking. Within the application framework 220, BLE enables edge devices to interact with user devices, exchange data, and trigger actions based on proximity or sensor data, enhancing user experiences and enabling context-aware applications.

Mesh networking protocols 225, such as Zigbee, Z-Wave, and Thread, enable edge devices to form self-organizing, self-healing networks for communication and data exchange. Mesh networks consist of interconnected nodes that relay data between each other, enabling communication over extended distances and through obstacles. Within the application framework 220, mesh networking protocols 225 enable edge devices to establish resilient, decentralized communication networks, facilitating peer-to-peer data exchange, group coordination, and collaborative decision-making in distributed edge computing environments.

Wi-Fi protocols 225, such as IEEE 802.11 standards, are widely used for providing local-area wireless connectivity to edge devices, enabling communication over Wi-Fi networks. Wi-Fi protocols 225 offer high-speed data transmission, low latency, and interoperability with existing network infrastructure, making them suitable for applications that require high-bandwidth communication or integration with enterprise networks. Within the application framework 220, Wi-Fi protocols 225 enable edge devices to connect to local networks, access cloud services, and exchange data with other devices, enabling seamless integration with existing IT infrastructure and enabling scalable deployment of edge AI applications.

Customer applications 230 play a central role within the Edge AI Architecture, serving as the primary interface through which end-users interact with and derive value from the system. These applications are tailored to specific use cases, business objectives, and user requirements, leveraging the capabilities of edge computing and AI technologies to deliver real-time insights, decision-making, and automation at the edge. Within the Edge AI Architecture, customer applications 230 are deployed on edge devices or cloud servers, depending on the deployment model and application requirements, and they interact with various components of the architecture to fulfill their intended functionalities.

One key aspect of customer applications 230 within the Edge AI Architecture is their ability to leverage AI models and algorithms deployed on edge devices for real-time inference tasks. These applications utilize pre-trained machine learning models to analyze sensor data, image streams, audio recordings, or other inputs collected by edge devices, enabling tasks such as object detection, anomaly detection, predictive maintenance, or environmental monitoring. By performing AI inference locally at the edge, customer applications 230 can minimize latency, reduce bandwidth consumption, and ensure data privacy and security, making them well-suited for latency-sensitive or bandwidth-constrained environments.

Moreover, customer applications 230 within the Edge AI Architecture often incorporate functionalities for data visualization, analytics, and decision support, enabling end-users to derive actionable insights and make informed decisions based on the processed data. These applications provide interactive dashboards, reports, alerts, and visualization tools that enable users to monitor system performance, track key metrics, detect trends, and identify anomalies in real-time. By presenting actionable insights in a user-friendly and intuitive manner, customer applications 230 empower end-users to optimize operations, improve efficiency, and drive business value through data-driven decision-making.

Furthermore, customer applications 230 may integrate with external systems, cloud platforms, or third-party services through APIs, enabling seamless data exchange, interoperability, and integration with existing IT infrastructure. These integrations enable customer applications 230 to access additional data sources, leverage external services for specific functionalities (e.g., geolocation services, weather APIs, payment gateways), and synchronize data with enterprise systems or cloud-based applications. By integrating with external systems, customer applications 230 can extend their capabilities, enhance user experiences, and leverage existing investments in IT infrastructure and software solutions.

Native apps 231 can be utilized within the customer applications 230 discussed in the Edge AI Architecture to provide tailored experiences and enhanced functionalities for end-users across various platforms, including mobile devices, tablets, and desktop computers. Native apps 231 are developed specifically for a particular operating system (e.g., iOS, Android, Windows) and leverage the native features and capabilities of the platform to deliver optimized performance, seamless user experiences, and access to device-specific functionalities. Within the customer applications 230, native apps 231 serve several key purposes to enhance user engagement, productivity, and accessibility.

Firstly, native apps 231 enable users to access the functionality of the customer applications 230 directly from their mobile devices, providing on-the-go access to real-time insights, decision-making tools, and automation features. By leveraging the capabilities of mobile devices, such as GPS, camera, accelerometer, and push notifications, native apps 231 can deliver context-aware experiences and enable functionalities such as location-based services, image capture, barcode scanning, or push notifications. This enhances user engagement, enables faster decision-making, and facilitates seamless interaction with the edge AI system regardless of the user's location or device.

Moreover, native apps 231 within the customer applications 230 offer offline capabilities, enabling users to access critical functionalities and data even when they are not connected to the internet or have limited network connectivity. By caching data locally on the device and implementing offline modes, native apps 231 ensure that users can continue to perform tasks, view information, and make decisions even in remote or offline environments. This is particularly beneficial for field workers, remote locations, or scenarios where network connectivity is unreliable or intermittent, ensuring uninterrupted access to essential functionalities and data.

Additionally, native apps 231 provide a consistent and familiar user experience across different platforms, leveraging platform-specific design guidelines, navigation patterns, and user interface components. By adhering to platform conventions and design principles, native apps 231 ensure that users can navigate, interact with, and understand the application interface intuitively, regardless of the device or operating system they are using. This enhances usability, reduces learning curves, and increases user satisfaction, resulting in a more engaging and enjoyable experience for end-users.

Furthermore, native apps 231 enable seamless integration with device-specific features and functionalities, such as biometric authentication, voice commands, and hardware sensors. By leveraging these device capabilities, native apps 231 can enhance security, accessibility, and usability, enabling features such as fingerprint authentication, voice-controlled commands, or augmented reality experiences. This not only enhances the overall user experience but also adds value to the customer applications 230 by leveraging the full potential of mobile devices and their capabilities.

Iot containers 232, encompassing telemetry data and data orchestration, play a pivotal role within the customer applications 230 discussed in the Edge AI Architecture, facilitating seamless integration, data exchange, and orchestration of IoT devices and sensor data. These containers serve as encapsulated environments for deploying, managing, and orchestrating IoT devices and data streams, enabling end-to-end connectivity, data ingestion, processing, and analysis within the edge computing environment. Within the customer applications 230, Iot containers 232 fulfill several key functions to enhance data-driven insights, decision-making, and automation capabilities.

Firstly, Iot containers 232 enable the ingestion and processing of telemetry data generated by IoT devices, sensors, and edge computing nodes deployed in the field. Telemetry data includes sensor readings, environmental measurements, device status updates, and other real-time data streams generated by IoT devices. Iot containers 232 provide lightweight, scalable runtime environments for collecting, aggregating, and processing telemetry data in real-time, enabling applications to analyze sensor data, detect patterns, and derive actionable insights for decision-making. By ingesting and processing telemetry data at the edge, Iot containers 232 minimize latency, reduce bandwidth consumption, and enable real-time monitoring, control, and automation of IoT devices and systems.

Moreover, Iot containers 232 facilitate data orchestration and workflow automation within the edge computing environment, enabling end-to-end data processing pipelines and workflows to be implemented seamlessly. These containers provide tools, libraries, and runtime environments for orchestrating data workflows, managing data pipelines, and coordinating tasks such as data transformation, enrichment, and routing. Within the customer applications 230, Iot containers 232 enable developers to design, deploy, and manage complex data processing pipelines that ingest data from multiple sources, apply AI algorithms for analysis, and generate insights or actions based on the processed data. By orchestrating data workflows, Iot containers 232 streamline data processing, improve efficiency, and enable automation of routine tasks, enhancing the scalability and agility of edge AI applications.

Furthermore, Iot containers 232 enable seamless integration and interoperability with external systems, cloud platforms, and third-party services through standardized interfaces and protocols 225. These containers provide connectors, adapters, and APIs for integrating with cloud-based IoT platforms, enterprise systems, and other IoT ecosystems, enabling seamless data exchange, synchronization, and integration. Within the customer applications 230, Iot containers 232 enable data to be securely transmitted and synchronized with cloud-based storage, databases, analytics platforms, or visualization tools, enabling centralized data management, analysis, and reporting. By integrating with external systems, Iot containers 232 enable customers to leverage existing investments in IT infrastructure, extend the capabilities of their edge AI applications, and unlock additional value from their IoT deployments.

AI containers 240 serve as essential components within the customer applications 230 discussed in the Edge AI Architecture, providing encapsulated environments for deploying, managing, and executing AI models and algorithms at the edge. These containers enable end-users to leverage the power of artificial intelligence for real-time insights, decision-making, and automation directly within their applications, without the need for extensive AI expertise or infrastructure. Within the customer applications 230, AI containers 240 fulfill several key functions to enhance data analysis, predictive capabilities, and automation.

Firstly, AI containers 240 enable the deployment and execution of pre-trained machine learning models and algorithms directly on edge devices, enabling real-time inference and analysis of data streams generated by IoT devices and sensors. These containers provide runtime environments for loading, initializing, and executing AI models, handling tasks such as data preprocessing, model inference, and result output. By leveraging AI containers 240, customer applications 230 can perform tasks such as object detection, image classification, anomaly detection, predictive maintenance, or natural language processing directly at the edge, minimizing latency, reducing bandwidth consumption, and enabling real-time decision-making and automation.

Moreover, AI containers 240 facilitate the deployment and management of AI models and algorithms in heterogeneous edge computing environments, spanning a diverse range of hardware platforms, operating systems, and deployment scenarios. These containers provide portability, scalability, and consistency across different edge devices, enabling AI models to be deployed seamlessly on edge servers, gateways, or edge devices with resource constraints. Within the customer applications 230, AI containers 240 enable developers to build and deploy AI-driven functionalities that are tailored to specific edge computing requirements, ensuring compatibility, interoperability, and performance across diverse deployment environments.

Furthermore, AI containers 240 enable seamless integration with data orchestration, data processing, and edge computing workflows within the edge AI architecture. These containers provide interfaces, APIs, and connectors for integrating with Iot containers 232, data processing pipelines, and orchestration frameworks, enabling end-to-end data analysis and automation workflows. Within the customer applications 230, AI containers 240 enable developers to incorporate AI-driven insights and actions into their edge computing workflows, enabling tasks such as automated decision-making, predictive analytics, or intelligent control based on real-time data streams. By integrating AI containers 240 with data orchestration and edge computing frameworks, customer applications 230 can leverage the full potential of AI technologies to enhance efficiency, productivity, and intelligence in diverse edge computing scenarios.

Computer vision models 242 can be effectively utilized within the AI containers 240 discussed in the Edge AI Architecture to enable a wide range of visual perception tasks directly at the edge. These models are specifically designed to analyze and interpret visual data, such as images and videos, enabling applications to extract valuable insights, make informed decisions, and automate processes based on visual information. Within the AI containers 240, computer vision models 242 fulfill several key functions to enhance edge computing capabilities, including object detection, image classification, semantic segmentation, and more.

Firstly, computer vision models 242 enable object detection, allowing edge devices to identify and locate objects of interest within images or video streams in real-time. These models utilize deep learning techniques, such as convolutional neural networks (CNNs), to detect and localize objects within an image, providing bounding boxes or segmentation masks that indicate the presence and location of objects. By leveraging computer vision models 242 within AI containers 240, customer applications 230 can perform tasks such as object tracking, inventory management, or security monitoring directly at the edge, without relying on cloud-based processing or external servers.

Moreover, computer vision models 242 enable image classification, enabling edge devices to categorize images into predefined classes or categories based on their visual content. These models learn to recognize patterns and features within images, enabling applications to classify objects, scenes, or events with high accuracy. Within the AI containers 240, computer vision models 242 can classify images in real-time, enabling applications such as visual inspection, quality control, or content-based filtering directly at the edge. By leveraging image classification capabilities, customer applications 230 can automate decision-making processes, identify anomalies or defects, and optimize operations based on visual data.

Furthermore, computer vision models 242 enable semantic segmentation, allowing edge devices to segment images into meaningful regions and assign semantic labels to individual pixels or regions within an image. These models utilize advanced deep learning architectures, such as fully convolutional networks (FCNs) or U-Net, to perform pixel-wise classification and delineate objects or structures within an image. Within the AI containers 240, semantic segmentation models can segment images in real-time, enabling applications such as medical image analysis, environmental monitoring, or autonomous navigation directly at the edge. By leveraging semantic segmentation capabilities, customer applications 230 can extract detailed information from visual data, enable fine-grained analysis, and support complex decision-making processes.

Additionally, computer vision models 242 enable facial recognition and biometric authentication, enabling edge devices to identify and verify individuals based on their facial features or other biometric characteristics. These models utilize deep learning techniques to extract and analyze facial features, enabling applications to recognize faces, verify identities, and enforce access control policies. Within the AI containers 240, facial recognition models can perform real-time identification and authentication tasks, enabling applications such as access control systems, attendance tracking, or personalized user experiences directly at the edge. By leveraging facial recognition capabilities, customer applications 230 can enhance security, privacy, and user experiences in diverse deployment scenarios.

Large language models 243, such as GPT (Generative Pre-trained Transformer) models, can be effectively utilized within the AI containers 240 discussed in the Edge AI Architecture to enable natural language understanding, generation, and interaction directly at the edge. These models are specifically designed to process and generate human-like text based on input prompts, enabling applications to understand and generate natural language responses in real-time. Within the AI containers 240, large language models 243 fulfill several key functions to enhance edge computing capabilities, including conversational AI, text generation, language translation, and more.

Firstly, large language models 243 enable conversational AI, allowing edge devices to engage in natural language conversations with users and provide intelligent responses based on their input. These models utilize advanced natural language processing (NLP) techniques, such as transformer architectures, to understand the semantics and context of user queries and generate appropriate responses. Within the AI containers 240, large language models 243 can perform real-time conversational AI tasks, enabling applications such as virtual assistants, chatbots, or customer support agents to interact with users directly at the edge. By leveraging conversational AI capabilities, customer applications 230 can enhance user engagement, provide personalized experiences, and automate customer interactions in diverse deployment scenarios.

Moreover, large language models 243 enable text generation, enabling edge devices to generate human-like text based on input prompts or context. These models can generate coherent and contextually relevant text across various domains, enabling applications to generate product descriptions, news articles, email responses, or creative content in real-time. Within the AI containers 240, large language models 243 can generate text dynamically, enabling applications such as content generation, summarization, or dialogue systems to create engaging and informative content directly at the edge. By leveraging text generation capabilities, customer applications 230 can automate content creation, streamline communication processes, and deliver personalized experiences to users in real-time.

Furthermore, large language models 243 enable language translation, allowing edge devices to translate text between different languages and facilitate multilingual communication in real-time. These models utilize machine learning algorithms to understand the semantics and syntax of text in one language and generate equivalent text in another language, enabling applications to break down language barriers and enable seamless communication across diverse linguistic communities. Within the AI containers 240, large language models 243 can perform language translation tasks, enabling applications such as translation services, multilingual chatbots, or internationalization tools to facilitate cross-cultural communication directly at the edge. By leveraging language translation capabilities, customer applications 230 can enhance accessibility, inclusivity, and global reach, enabling users to communicate and interact effectively in their preferred languages.

Additionally, large language models 243 enable sentiment analysis and text classification, allowing edge devices to analyze the sentiment and emotions expressed in textual data and classify text into predefined categories or topics. These models utilize machine learning techniques to identify patterns and features within text data, enabling applications to categorize text based on sentiment, sentiment, emotions, or topics. Within the AI containers 240, large language models 243 can perform sentiment analysis and text classification tasks, enabling applications such as social media monitoring, brand reputation management, or content moderation to analyze and classify textual data in real-time. By leveraging sentiment analysis and text classification capabilities, customer applications 230 can gain insights into user preferences, sentiments, and trends, enabling them to make data-driven decisions and optimize user experiences effectively.

A network stack 241 can be utilized within the AI containers 240 discussed in the Edge AI Architecture to enable communication, data exchange, and integration with external systems, cloud platforms, and other edge devices within the network. The network stack 241 encompasses a set of protocols, libraries, and services that facilitate network communication, including networking protocols such as TCP/IP, UDP, HTTP, and MQTT, as well as networking libraries, drivers 215, and middleware 222 components. Within the AI containers 240, the network stack 241 fulfills several key functions to enhance edge computing capabilities, including connectivity, data transmission, security, and interoperability.

Firstly, the network stack 241 enables connectivity and communication between AI containers 240 deployed on edge devices and external systems or cloud platforms over wired or wireless networks. The network stack 241 provides support for networking protocols such as TCP/IP and UDP, enabling edge devices to establish connections, exchange data packets, and communicate with remote servers or services. By leveraging the network stack 241, AI containers 240 can transmit data, receive commands, and synchronize state information with external systems, enabling seamless integration and interoperability within the edge computing ecosystem.

Moreover, the network stack 241 facilitates data transmission and streaming between AI containers 240 deployed on edge devices and other edge devices or sensors within the network. The network stack 241 provides support for communication protocols such as MQTT, CoAP, or AMQP, enabling edge devices to publish and subscribe to data streams, send notifications, or exchange messages in a lightweight and efficient manner. By leveraging the network stack 241, AI containers 240 can stream sensor data, telemetry data, or control messages between edge devices, enabling real-time data exchange and collaboration within distributed edge computing environments.

Furthermore, the network stack 241 enables security and encryption of data transmitted between AI containers 240 and external systems or edge devices within the network. The network stack 241 provides support for security protocols such as TLS/SSL, IPSec, or VPN, enabling edge devices to encrypt data, authenticate connections, and ensure data integrity and confidentiality during transmission. By leveraging the network stack 241, AI containers 240 can establish secure and encrypted communication channels, protecting sensitive data and ensuring compliance with security and privacy regulations within the edge computing ecosystem.

Additionally, the network stack 241 facilitates interoperability and integration with edge computing frameworks, orchestration platforms, and management systems deployed within the network. The network stack 241 provides support for standardized interfaces, APIs, and protocols such as RESTful APIs, gRPC, or OpenAPI, enabling AI containers 240 to interact with edge computing services, orchestration frameworks, and management platforms seamlessly. By leveraging the network stack 241, AI containers 240 can register with edge computing platforms, discover available services, and exchange metadata or control messages, enabling dynamic and flexible deployment of edge AI applications within the network.

Developer support 260 within the edge AI architecture encompasses various resources, tools, and services aimed at assisting developers in building, deploying, and managing edge AI applications effectively. This support typically includes access to large language model (LLM) libraries, GitHub repositories, and comprehensive documentation to facilitate the development process. Firstly, LLM support involves providing developers with access to pre-trained language models, such as GPT (Generative Pre-trained Transformer), BERT (Bidirectional Encoder Representations from Transformers), or T5 (Text-To-Text Transfer Transformer), tailored for specific natural language processing (NLP) tasks. These pre-trained models serve as powerful building blocks for developing natural language understanding (NLU) and generation functionalities within edge AI applications. Developer support 260 may include access to model repositories, model serving frameworks, and deployment tools that streamline the integration of LLMs into edge AI applications, enabling developers to leverage state-of-the-art NLP capabilities without the need for extensive training or expertise.

Moreover, GitHub use cases play a crucial role in developer support 260 by providing access to open-source repositories, sample code, and community contributions that accelerate the development and collaboration process. Edge AI architecture may include GitHub repositories containing example applications, code snippets, and best practices for implementing various edge computing and AI functionalities. Developers can leverage these resources to learn, experiment, and bootstrap their edge AI projects, benefiting from the collective knowledge and expertise of the developer community. Additionally, GitHub repositories may host contributions from platform developers, partners, and third-party developers, fostering collaboration, innovation, and knowledge-sharing within the edge AI ecosystem.

Furthermore, comprehensive documentation is essential for providing developers with guidance, tutorials, API references, and technical documentation that facilitate the development, deployment, and maintenance of edge AI applications. Developer support 260 includes well-documented APIs, SDKs (Software Development Kits), and programming guides that outline the capabilities, usage patterns, and best practices for integrating edge AI functionalities into applications. Documentation may cover topics such as model deployment, inference optimization, data preprocessing, error handling, and troubleshooting, enabling developers to navigate the complexities of edge AI development effectively. Additionally, developer support 260 may include tutorials, code samples, and step-by-step guides that demonstrate common use cases, implementation patterns, and deployment strategies, empowering developers to build robust, scalable, and efficient edge AI applications.

Developer environment 260s within the edge AI architecture are designed to provide developers with the necessary tools, resources, and infrastructure to build, test, and deploy edge AI applications efficiently. These environments typically encompass a range of command-line toolchains, diagnostic tools, build and package tools, as well as support for multiple programming languages, enabling developers to work seamlessly across diverse development scenarios.

Command-line toolchains are essential components of developer environment 260s, providing developers with command-line interfaces (CLIs) and utilities for performing various development tasks, such as code compilation, package management, version control, and deployment. These toolchains often include popular command-line interfaces, such as Git for version control, Docker for container management, and package managers like npm or pip for dependency management. By leveraging command-line toolchains, developers can automate repetitive tasks, streamline development workflows, and maintain consistency across development environments, enhancing productivity and collaboration within development teams.

Diagnostic tools play a crucial role in developer environment 260s by providing developers with insights into application performance, resource utilization, and runtime behavior, enabling them to identify and troubleshoot issues effectively. These tools may include profiling tools, debuggers, monitoring agents, and logging frameworks that enable developers to analyze application behavior, diagnose performance bottlenecks, and optimize code for efficiency. By leveraging diagnostic tools, developers can ensure the reliability, performance, and scalability of edge AI applications, enabling them to deliver high-quality solutions that meet user expectations and business requirements.

Build and package tools are essential components of developer environment 260s, enabling developers to compile, bundle, and package edge AI applications for deployment on edge devices or cloud platforms. These tools may include build automation frameworks, packaging utilities, and deployment scripts that streamline the build process and generate deployable artifacts, such as container images, executable binaries, or firmware packages. By leveraging build and package tools, developers can automate the build process, ensure reproducibility, and simplify the deployment of edge AI applications across diverse deployment environments, enabling faster time-to-market and more efficient release cycles.

Additionally, developer environment 260s provide support for multiple programming languages, enabling developers to choose the language and framework that best suits their development preferences and requirements. These environments may include support for popular programming languages such as Python, JavaScript, Java, or C/C++, as well as frameworks and libraries commonly used in edge AI development, such as TensorFlow, PyTorch, OpenCV, or scikit-learn. By providing multi-language support, developer environment 260s accommodate diverse development scenarios and enable developers to leverage their existing skills and expertise in building edge AI applications, fostering innovation and flexibility within development teams.

Although a specific embodiment for edge video processing suitable for carrying out the various steps, processes, methods, and operations described herein is discussed with respect to FIG. 2, any of a variety of systems and/or processes may be utilized in accordance with embodiments of the disclosure. For example, the specific layout of components may vary depending on the application and/or deployment. The elements depicted in FIG. 2 may also be interchangeable with other elements of FIGS. 1 and 3-10 as required to realize a particularly desired embodiment.

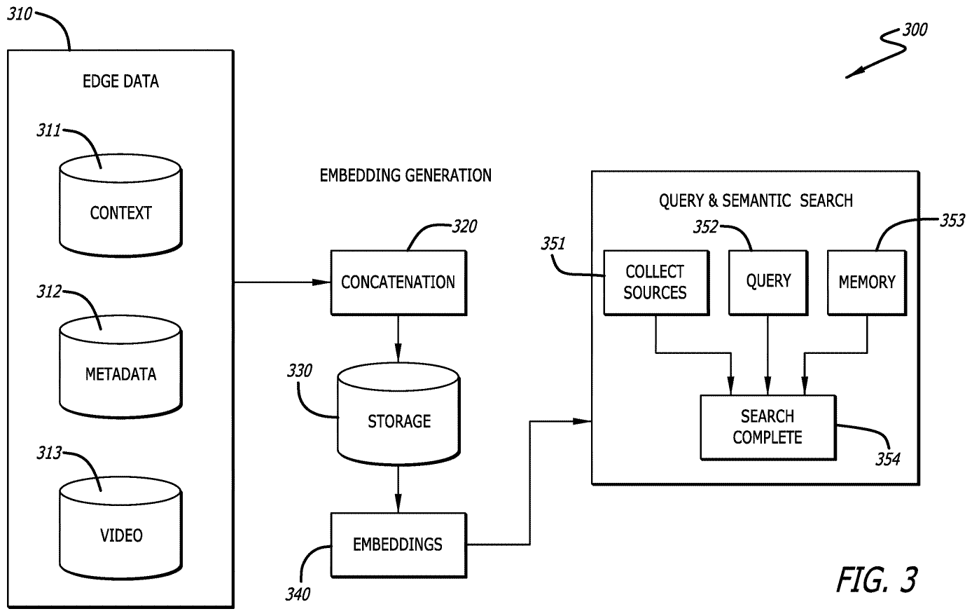

Referring to FIG. 3, a conceptual system block chart 300 for edge video processing in accordance with various embodiments of the disclosure is shown. Computer vision, an interdisciplinary field merging computer science and artificial intelligence, revolutionizes our ability to interpret and understand the visual world. One of its pivotal applications is object detection, wherein computers identify and locate objects within images or video frames. It all begins with capturing images or video frames using cameras or similar devices. Preprocessing techniques are then employed to enhance image quality, mitigate noise, and normalize lighting conditions. These steps optimize subsequent object detection algorithms.

Feature extraction often occurs. Algorithms analyze images to identify patterns like edges, corners, textures, colors, and shapes—distinctive attributes aiding in object recognition. Object localization follows, determining objects' spatial placement via techniques like bounding boxes. Next comes object classification. Algorithms are trained on labeled datasets using machine learning methods such as convolutional neural networks (CNNs). By analyzing features within bounding boxes, they predict objects' identities, categorizing them into predefined classes like “person” or “car.”

Post-processing steps refine results. False positives may be filtered out, overlapping detections merged, or geometric constraints applied to ensure consistency. Finally, output visualization presents results. Detected objects and their classifications overlay the original image or appear in a separate format, often featuring bounding boxes and class labels. In real-world scenarios, such as surveillance, autonomous vehicles, medical imaging, and robotics, computer vision's object detection capabilities find numerous applications. Advances in deep learning and hardware accelerate these systems, empowering them to detect and recognize objects with unprecedented accuracy and efficiency across various environments.

A network with Internet of Things (IoT) devices typically consists of interconnected physical objects or “things” embedded with sensors, actuators, and communication capabilities. These devices collect and exchange data over the internet or other networks, enabling them to interact with each other and with cloud-based services or applications. The structure of such a network involves several key components. At the edge, IoT devices gather data from their surroundings, such as temperature, humidity, motion, or other environmental variables. These devices may include sensors, actuators, microcontrollers, and communication modules. The collected data is then transmitted to a local gateway or hub, which serves as an intermediary between the IoT devices and the broader network infrastructure. The gateway aggregates and processes data, performs protocol translations, and manages communication with the cloud or other remote services. From the gateway, data is sent to the cloud, where it is stored, analyzed, and acted upon by applications or services. Cloud platforms provide storage 330, processing, and analytics capabilities, enabling organizations to derive insights from IoT data and automate decision-making processes. In addition to the cloud, some IoT deployments may utilize edge computing resources, where data processing and analysis occur closer to the source of data generation, reducing latency and bandwidth requirements. Overall, the network architecture of an IoT deployment involves distributed computing resources, spanning from edge devices to cloud-based platforms, to enable the seamless collection, processing, and utilization of data from connected devices.

Computer vision processing on a network with IoT devices involves integrating cameras or imaging sensors into the IoT ecosystem to capture visual data, which is then processed and analyzed to extract meaningful insights. At the edge of the network, IoT devices equipped with cameras or image sensors capture images or video streams. These devices may include surveillance cameras, drones, or smart cameras embedded in various environments. Once captured at the edge, the visual data is then transmitted to the cloud or central server for analysis and storage 330. In the cloud, powerful computational resources and machine learning algorithms can be applied to perform tasks such as object recognition, scene understanding, and anomaly detection. The insights derived from the visual data can then be used to trigger actions, provide real-time alerts, or generate reports to support decision-making processes. By combining computer vision processing with IoT devices and network infrastructure, organizations can unlock new opportunities for applications such as smart surveillance, industrial automation, retail analytics, and more, enabling them to extract valuable insights from visual data collected in various environments.

Video data 313 collected at the edge of a network for computer vision processing encompasses a range of visual information captured by cameras or imaging sensors deployed in the field. This data typically includes sequences of frames, each containing pixel-level information representing the scene observed by the camera at a particular moment in time. Within these frames, various elements may be present, such as objects, people, animals, vehicles, and environmental features like buildings, roads, or vegetation. Additionally, the video data 313 may include temporal information, capturing the dynamics of the scene over time, such as motion patterns, changes in object positions, and interactions between objects. The quality and resolution of the video data 313 can vary depending on factors like camera specifications, lighting conditions, and environmental factors. Preprocessing techniques may be applied at the edge to enhance the quality of the video data 313, mitigate noise, or compress the data for efficient transmission over the network. Ultimately, the video data 313 collected at the edge serves as the foundation for computer vision algorithms to analyze, extract insights, and make sense of the visual world in real-time or near-real-time applications, enabling various use cases such as surveillance, monitoring, object detection, and activity recognition.

Alongside the visual information contained in video data 313 collected at the edge of a network, various types of metadata 312 can provide valuable context and additional insights. This metadata 312 may include timestamps indicating the exact moment each frame was captured, enabling temporal analysis and synchronization with other data sources. Geospatial metadata 312, such as GPS coordinates or location tags, can provide information about where the video was recorded, facilitating spatial analysis and mapping applications. Other types of metadata 312 may include camera settings, such as exposure, focal length, and aperture, which can affect the quality and characteristics of the video. Additionally, metadata 312 tags or annotations may be added manually or automatically to identify specific objects, events, or attributes within the video, aiding in search 354, indexing, and retrieval tasks. Metadata 312 plays a crucial role in enhancing the interpretability, usability, and utility of video data 313 for computer vision applications, enabling more informed analysis and decision-making processes.

In addition to basic metadata 312 like timestamps and geospatial information, video data 313 often includes context data 311 that provides deeper insights into the content and relationships within the scenes captured. Video features, such as motion vectors, optical flow, and keyframe selection, offer valuable context about the dynamics and visual characteristics of the video, aiding in tasks like action recognition and scene understanding. Object relations and interactions can be inferred from metadata 312 indicating the spatial and temporal relationships between objects, such as bounding boxes, trajectories, or semantic segmentation masks. These relationships help in analyzing object behavior, tracking movements, and identifying complex events involving multiple objects. Semantic annotations or tags associated with objects or regions within the video provide context about their identities, attributes, or actions, enabling more meaningful interpretation and analysis. Context data 311 may also include environmental factors like weather conditions, lighting conditions, or ambient noise, which influence the appearance and behavior of objects in the video. By incorporating context data 311 related to video features, object relations, and environmental factors, computer vision systems can achieve a deeper understanding of the visual content, enabling more accurate and context-aware analysis for a wide range of applications, from surveillance and security to autonomous systems and augmented reality.

In addition to context data 311, metadata 312, and video data 313, various other types of data may be captured at the edge of the network for processing in computer vision systems. This includes sensor data from additional environmental sensors deployed alongside cameras, such as temperature sensors, humidity sensors, accelerometers, or LiDAR sensors. Integrating sensor data with video data 313 provides a richer understanding of the environment, enabling correlations between visual cues and physical parameters. Furthermore, contextual information such as contextual awareness can be derived from data sources like contextual knowledge data 310 bases, historical data, or contextual signals from connected devices or systems. This contextual awareness enhances the interpretability and relevance of the analysis results, enabling more context-aware and adaptive computer vision applications. Additionally, metadata 312 about network conditions, device status, or system health metrics may be collected to monitor and optimize the performance of the edge computing infrastructure. By leveraging a diverse range of data sources at the edge, computer vision systems can achieve more comprehensive and robust analysis, enabling intelligent decision-making and automation in various domains.

To process all the edge data 310—comprising context data 311, metadata 312, and video data 313—with concatenation 320 before storage 330, you would first need to gather and organize the different types of data from their respective sources at the edge of the network. This involves collecting video streams, sensor readings, metadata 312, and any other relevant contextual information. Once collected, the data needs to be formatted and structured in a way that facilitates concatenation 320. This may involve standardizing data formats, aligning timestamps, and organizing metadata 312 to correspond with the associated video frames or sensor readings.

Next, you would concatenate the different types of data into a single unified dataset. This could be achieved by merging the data streams based on common identifiers or timestamps, ensuring that each data point retains its relevant contextual information. For example, sensor readings could be appended to corresponding video frames, and metadata 312 could be attached as additional attributes. After concatenation 320, the processed data can be stored in a suitable storage 330 system, such as a database or distributed file system. By consolidating the various types of edge data 310 into a single dataset, you simplify storage 330 management and streamline subsequent analysis tasks. Additionally, storing concatenated data allows for easier retrieval and querying, as all relevant information is stored together.

This concatenated edge data 310 can then be accessed and utilized by computer vision systems for tasks such as object detection, activity recognition, or anomaly detection. The comprehensive dataset provides a holistic view of the environment, enabling more accurate and context-aware analysis. Moreover, by processing and concatenating edge data 310 before storage 330, you lay the foundation for more efficient and effective utilization of the data in downstream applications and workflows. Using the concatenated edge data 310 for query search 354 related to stored data involves several key steps. Initially, the data undergoes feature extraction, where relevant features are extracted from the video frames, sensor readings, metadata 312, and contextual information. This process involves leveraging computer vision algorithms to extract visual features from the video data 313 and considering metadata 312 and context data 311 as additional input features. Simultaneously, features are extracted from sensor data using techniques tailored to the specific sensor modalities. Once features are extracted, they are transformed into a lower-dimensional embedding space through embedding generation. This step aims to map the high-dimensional feature representations into a more compact and semantically meaningful space. Techniques like principal component analysis (PCA) or autoencoders are commonly used for dimensionality reduction and feature compression, allowing for efficient storage 330 and retrieval of data.

After embedding generation, the embeddings 340 are organized into an index structure to facilitate efficient similarity search 354. Indexing techniques such as locality-sensitive hashing (LSH) or tree-based structures like KD-trees or ball trees are employed to organize the embeddings 340 for fast retrieval based on similarity metrics. When a query 352 is initiated, features are extracted from the query data and transformed into the same embedding space as the stored data. A similarity search 354 is then performed within the index to identify the most similar embeddings 340 to the query. This process effectively retrieves stored data entries that are most relevant or similar to the query criteria.

Once the similar embeddings 340 are retrieved, they are ranked based on their similarity scores or distance metrics. Finally, the ranked results are presented to the user, providing relevant data entries that match the query criteria. This approach enables efficient content-based search 354 and retrieval, facilitating tasks such as object recognition, scene understanding, and anomaly detection in various applications such as video surveillance, smart environments, and industrial monitoring. By leveraging embeddings 340 derived from concatenated edge data 310 and employing similarity search 354 techniques, organizations can effectively retrieve relevant information from stored data in response to user queries, enhancing decision-making processes and enabling actionable insights.

Generating a semantic search 354 on the concatenated edge data 310 based on a query 352, available memory 353, and any collected sources 351 can involve understanding the underlying semantics of both the query 352 and the stored data. Unlike traditional keyword-based searches, semantic searches aim to comprehend the meaning and context of the search query to retrieve more relevant results. To achieve this, natural language processing (NLP) techniques can be employed to analyze and interpret the query text, extracting semantic entities, relationships, and concepts.

Once the query is processed, semantic embeddings 340 are generated to represent the semantic content of the query. This involves encoding the semantic information extracted from the query text into a numerical vector representation using techniques such as word embeddings 340 or sentence embeddings 340. These semantic embeddings 340 capture the semantic similarity and relationships between words or phrases in the query, enabling more nuanced search queries that go beyond simple keyword matching.

Similarly, the stored data, including video data 313, sensor readings, metadata 312, and contextual information, is preprocessed to extract semantic features and representations. This may involve analyzing textual metadata 312, contextual information, and associated annotations to derive semantic attributes and relationships. For video data 313, semantic features can be extracted using computer vision techniques to identify objects, scenes, actions, and other semantic elements within the video frames.

Once both the query and the stored data are represented in a semantic embedding space, a semantic similarity search 354 is performed to identify the most relevant data entries that match the semantic content of the query. This involves computing the semantic similarity between the query embeddings 340 and the embeddings 340 of the stored data entries, considering the semantic context and relationships encoded in the embeddings 340. Techniques such as cosine similarity or Euclidean distance are commonly used to measure the similarity between embeddings 340.

The retrieved data entries are then ranked based on their semantic similarity to the query, with higher-ranked matches considered more relevant to the query semantics. These results are presented to the user as semantic search results, providing a more intuitive and contextually relevant representation of the stored data based on the semantic content of the query. By leveraging semantic search techniques, organizations can enhance the discoverability and relevance of information within their data repositories, enabling more effective decision-making and knowledge discovery processes.

Although a specific embodiment for a block chart for edge video processing suitable for carrying out the various steps, processes, methods, and operations described herein is discussed with respect to FIG. 3, any of a variety of systems and/or processes may be utilized in accordance with embodiments of the disclosure. For example, the specific configuration or data flows may be adjusted based on the specific application or deployment desired. The elements depicted in FIG. 3 may also be interchangeable with other elements of FIGS. 1-2 and 4A-10 as required to realize a particularly desired embodiment.

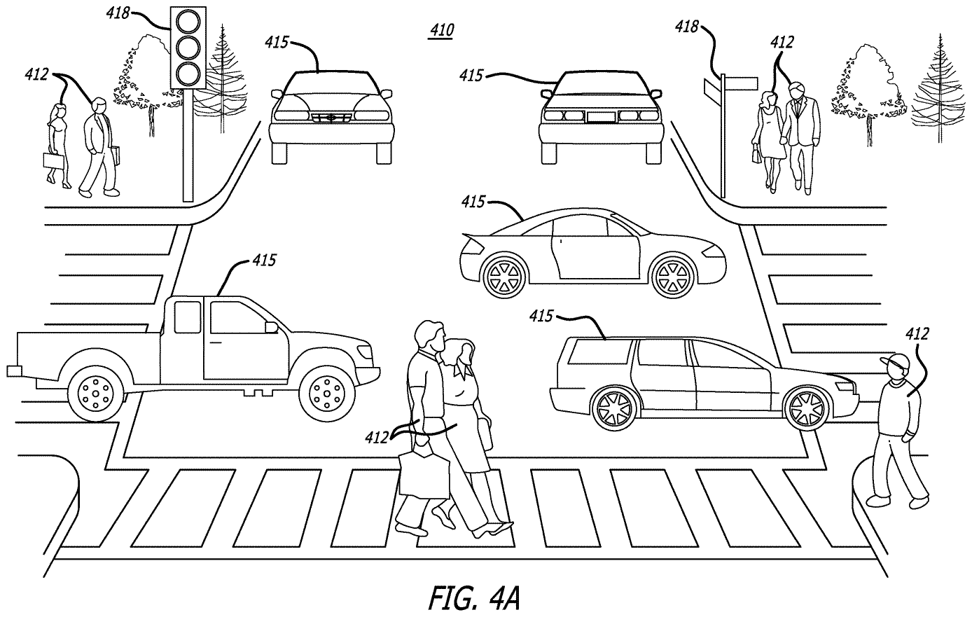

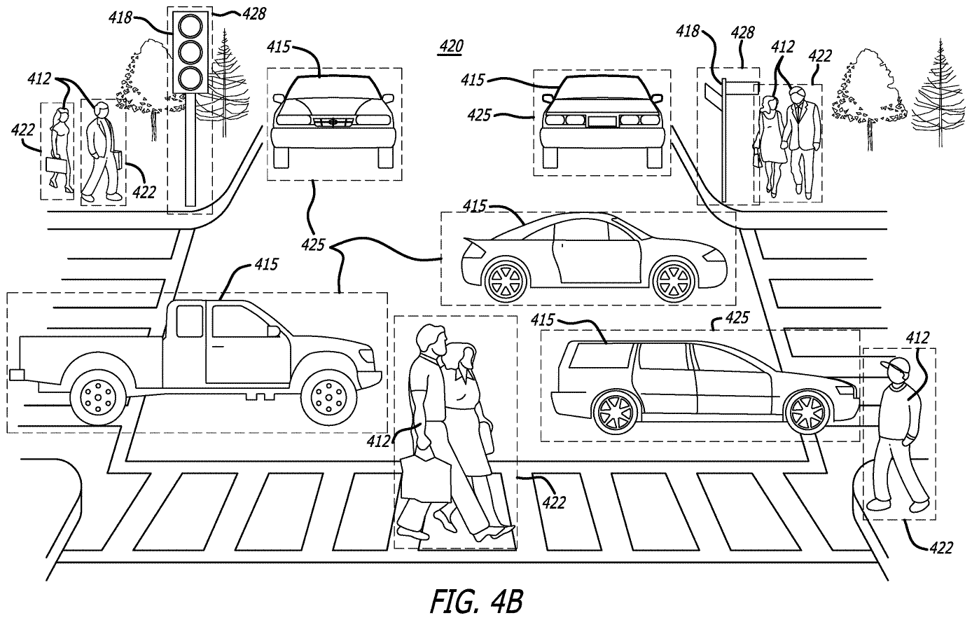

Referring to FIG. 4A, a conceptual illustration of a sample image 410 within one or more sets of image data in accordance with an embodiment of the disclosure is shown. Utilizing the example of an edge camera, such a camera associated with an automobile capturing image data for use in one or more assisted driving features, the sample image 410 shows a scene which may be captured by an automobile while driving or parked at a stop light. In this sample image 410, there may be a number of items which will have unique levels of motion and or priority when processing. In the embodiment depicted in FIG. 4A, the sample image 410 comprises a number of pedestrians 412, other automobiles/vehicles 415, and landmark objects 418 such as street signs and traffic lights. Once captured, the sample image 410 may be processed by an edge device without having to send all of the data to a centralized server.

In various embodiments, similar video data may be captured from a variety of deployments. For example, images may be captured by one or more edge cameras from retail environments, or other environments that may be desired to be monitored. As those skilled in the art will recognize, the specific device and/or environment can vary and cover multiple locations.

Although a specific embodiment for a sample image within one or more sets of image data suitable for carrying out the various steps, processes, methods, and operations described herein is discussed with respect to FIG. 4A, any of a variety of systems and/or processes may be utilized in accordance with embodiments of the disclosure. For example, the number of elements, subjects, and/or objects that are tracked can vary based on the environment monitored. The elements depicted in FIG. 4A may also be interchangeable with other elements of FIGS. 1-3 and 4B-10 as required to realize a particularly desired embodiment.

Referring to FIG. 4B, a conceptual illustration of a sample image 420 within one or more sets of image data processed to recognize a plurality of subjects in accordance with an embodiment of the disclosure is shown. In various embodiments, the automobile or other image processing device may analyze the sample image 420 and generate a plurality of bounding boxes 422, 425, 428 around detected subjects of interest such as, but not limited to, pedestrians 412, other automobiles/vehicles 415, and landmark objects 418 such as street signs and traffic lights. As those skilled in the art will recognize, the use of a bounding box 422, 425, 428 is not the only method of selecting an area of an image comprising a detected object. It is contemplated that an image mask, such as a pixel-level image mask may be suitable for use in segmentation a sample image 420.

In most embodiments, the bounding box 422, 425, 428 will be comprised of a rectangle that encases the detected object and has a size that includes the maximum height and width of the detected object. Based on the desired application and capabilities of the image capturing device, the generation of the bounding box 422, 425, 428 may be generated by a specialized logic or by the low-power, fast-response machine learning logic. Additionally, it is contemplated that each recognized subject within the sample image 420 may be segmented with a unique bounding box and/or image mask and may be grouped together based on recognized subject type.

In more embodiments, the bounding boxes or other segmentation can be formatted as metadata, which can be processed into one or more contextual cues, data, or other inputs that can be passed to a large language model. This can allow for the generation and extraction of contextual data, as well contextual features. These contextual features can be utilized to decide if a state should change, if a behavior is detected, and/or the potential compression levels to be used.

Although a specific embodiment for a sample image within one or more sets of image data processed to recognize a plurality of subjects suitable for carrying out the various steps, processes, methods, and operations described herein is discussed with respect to FIG. 4B, any of a variety of systems and/or processes may be utilized in accordance with embodiments of the disclosure. For example, the sample image 420 can be processed in different ways beyond bounding boxes to extract detection of objects, subjects, etc. The elements depicted in FIG. 4B may also be interchangeable with other elements of FIGS. 1-4A and 5-10 as required to realize a particularly desired embodiment.

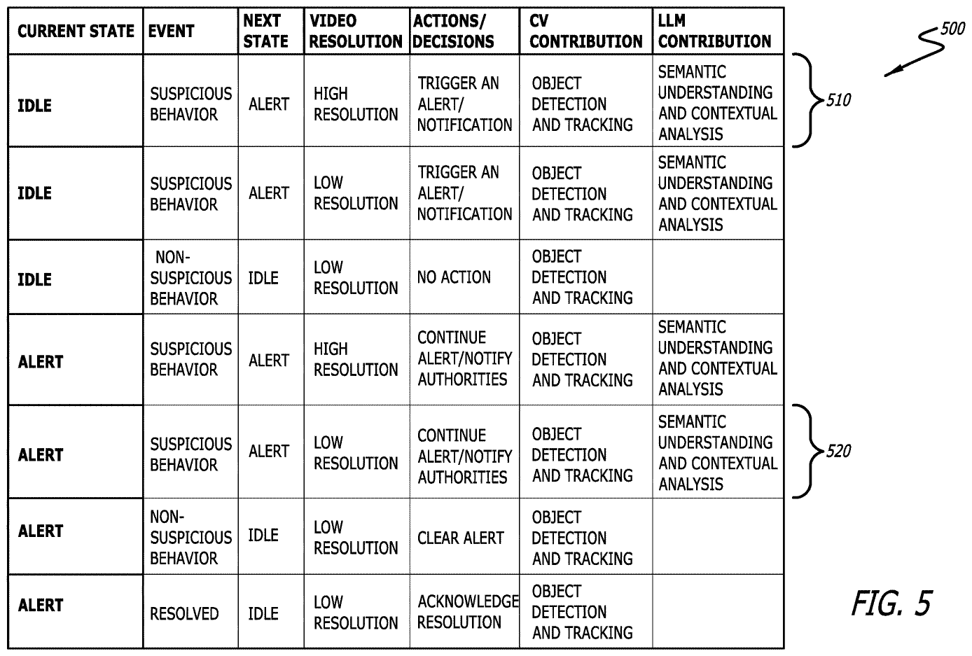

Referring to FIG. 5, a conceptual matrix 500 of behavior detection within video data processed with edge devices in accordance with various embodiments of the disclosure is shown. As previously discussed, the deployment utilized by a network and any associated edge devices can vary depending on the application desired. One example is a retail environment that can have numerous area monitored by cameras. These cameras can be positioned to monitor for suspicious behavior which can then alert one or more administrators, managers, or other logics that some action should be done in response. This can be done by assigning a state to each moment, frame, or unit of time associated with each camera or system.

In the matrix 500 shown in FIG. 5, the current state is shown with a subsequent event that is detected, which can be classified as suspicious, non-suspicious, or resolved. These events, and the detected behaviors can then trigger one or more changes in the state. For example, in a first condition 510, the current state is idle, but then a suspicious behavior is detected (such as a shopper putting merchandise in their pocket, etc.). This can trigger a state change from idle to alert. As a result, the system may want to store the video data associated with this state at a higher resolution (by utilizing a lower compression rate for example). An alert may subsequently be triggered. This can be achieved by a computer vision model generating object detection and tracking data, while a large language model generates semantic understanding and contextual analysis.

Additionally, in a second condition 520, the current state is an alert state, but remains in an alert state due to continued suspicious behavior being detected. However, the system may decide or be configured for storing this subsequent edge data at a lower resolution since the alert has already been generated. The alert in question may continue to be triggered as the state remains the same. Again, this can be achieved by a computer vision model generating object detection and tracking data, while a large language model generates semantic understanding and contextual analysis.

Although a specific embodiment for a matrix of behavior detection suitable for carrying out the various steps, processes, methods, and operations described herein is discussed with respect to FIG. 5, any of a variety of systems and/or processes may be utilized in accordance with embodiments of the disclosure. For example, the specific layout and changes shown in the matrix 500 can vary depending on the application desired and may vary within the same matrix based on one or more other settings or events. The elements depicted in FIG. 5 may also be interchangeable with other elements of FIGS. 1-4B and 6-10 as required to realize a particularly desired embodiment.

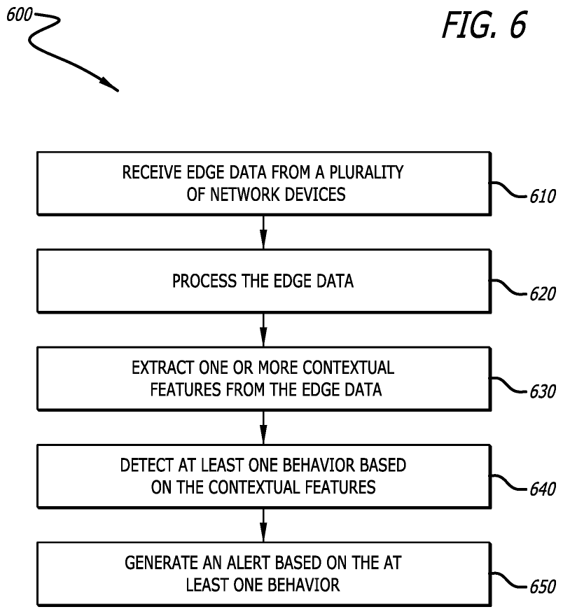

Referring to FIG. 6, a flowchart depicting a process 600 for processing edge data for behaviors in accordance with various embodiments of the disclosure is shown. In many embodiments, the process 600 can receive edge data from a plurality of network devices (block 610). The edge data can be comprised of various types of data. In certain embodiments, the edge data can comprise video data, metadata, and/or context data. The video data can be captured by one or more camera devices, such as IoT devices.

In a number of embodiments, the process 600 can process the edge data (block 620). The edge data can be processed in a variety of ways. In some embodiments, the edge data can be processed to extract, capture, group or otherwise process video data from one or more environments. The processing can be done to pre-format or change the edge data for subsequent processing. In still more embodiments, the processing can be associated with utilizing the edge data as an input into one or more computer vision models or the like.

In more embodiments, the process 600 can extract one or more contextual features from the edge data (block 630). As those skilled in the art will recognize, the edge data may contain video data that may be of various subjects, objects, or environments. These may be detected and processed into various context data. For example, the output of a computer vision model may be configured to indicate what items are detected within video data. These indications can be formatted as context data. In various embodiments, the context data may be further utilized as input into one or more large language model to extract further context data.

In additional embodiments, the process 600 can detect at least one behavior based on the contextual features (block 640). Behaviors can be customized for the specific application or deployment desired. For example, in a retail store deployment, behaviors may be trained to detect suspicious behavior, while in a driving deployment, behaviors related to pedestrians may be detected. In certain embodiments, the behavior detection can be configured based on the output of one or more large language models that extract various context data and/or contextual features.

In further embodiments, the process 600 can generate an alert based on the at least one behavior (block 650). As described above, the specific behavior detection can vary based on the desired deployment. However, it is often the case that specific behaviors are tracked such that subsequent actions can occur based on those detected behaviors. In response, the process 600 can generate alerts based on a detected behavior. These alerts may be transmitted to a relevant device, location, or logic that is associated with carrying out a subsequent reaction to that behavior, etc.

Although a specific embodiment for a process for processing edge data for behaviors suitable for carrying out the various steps, processes, methods, and operations described herein is discussed with respect to FIG. 6, any of a variety of systems and/or processes may be utilized in accordance with embodiments of the disclosure. For example, the edge data may be processed and stored for eventual processing prior to extraction and behavior detection. The elements depicted in FIG. 6 may also be interchangeable with other elements of FIGS. 1-5 and 7-10 as required to realize a particularly desired embodiment.

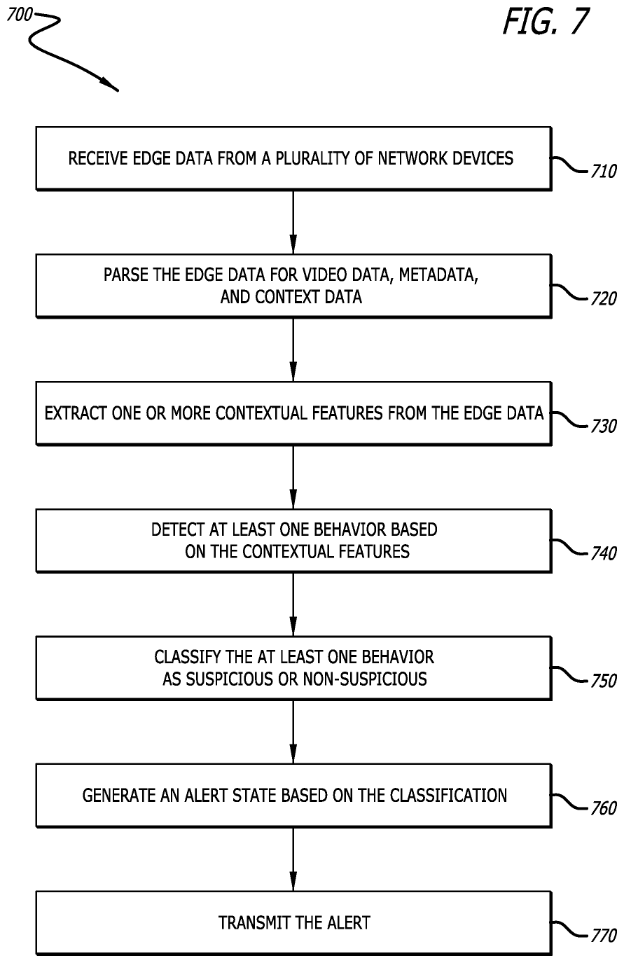

Referring to FIG. 7, a flowchart depicting a process 700 for determining alert states from edge data in accordance with various embodiments of the disclosure is shown. In many embodiments, the process 700 can receive edge data from a plurality of network devices (block 710). For example, a system may have a plurality of camera devices deployed at one or more locations that are configured to track a variety of environments, etc. However, edge data may be received from various storage devices as well.

In a number of embodiments, the process 700 can parse the edge data for video data, metadata, and context data (block 720). As described above, edge data may be comprised of various data. In certain embodiments, the edge data may be raw, unprocessed data, that, in response to processing, can be parsed into separate video data, metadata, and/or context data. The parsing can be done prior to storage and may be done by one or more devices on the edge of a network deployment.

In more embodiments, the process 700 can extract one or more contextual features from the edge data (block 730). The extraction of contextual features from edge data can be done by parsing the edge data for context data. In some embodiments, the extraction can be comprised of utilizing at least a portion of the edge data as an input into one or more computer vision models. The computer vision model(s) can be configured to output contextual features that can be extracted from the edge data.

In additional embodiments, the process 700 can detect at least one behavior based on the contextual features (block 740). In some embodiments, the output of the computer vision model(s) can be further input, along with potential other data, into a large language model or similar machine learning process. This output can be utilized to detect one or more behaviors present within the edge data.

In further embodiments, the process 700 can classify the at least one behavior as suspicious or non-suspicious (block 750). As described above, some deployments may be configured within environments that are retail based or the like. In these embodiments, there may be behaviors that are monitored that can be classified. The classifications of the behaviors may be tuned to focus on suspicious or non-suspicious behaviors. These behaviors can be related to various activities that can be occurring within the deployment environment, such as a retail store, working area, or other monitored location.

In still more embodiments, the process 700 can generate an alert state based on the classification (block 760). In some embodiments, the detection of a suspicious behavior may be configured to trigger the generation of an alert associated with that behavior. For example, if a shopper is detected as exhibiting a suspicious behavior related to shoplifting, the alert may be generated that is formatted to indicate that shoplifting may be taking place.

In various embodiments, the process 700 can transmit the alert (block 770). The transmission may be to another device or logic that can be configured to alert a user, administrator, or other logic regarding the event, such as suspicious behavior, etc. In some embodiments, the transmission can be broadcast so one or more devices configured to receive the alert can do so. However, in additional embodiments, the transmission may be directed to a specific device or logic that is a known destination for that type of alert.

Although a specific embodiment for a process for determining alert states from edge data suitable for carrying out the various steps, processes, methods, and operations described herein is discussed with respect to FIG. 7, any of a variety of systems and/or processes may be utilized in accordance with embodiments of the disclosure. For example, the transmission of the alert may be done at a given period of time or based on one or more heuristics. The elements depicted in FIG. 7 may also be interchangeable with other elements of FIGS. 1-6 and 8-10 as required to realize a particularly desired embodiment.

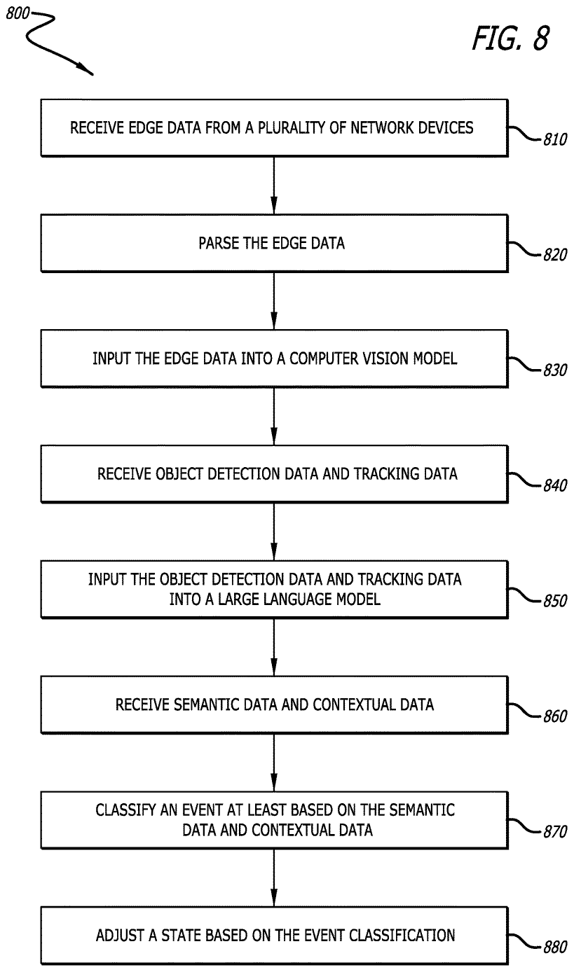

Referring to FIG. 8, a flowchart depicting a process 800 for adjusting a state based on an event classification in accordance with various embodiments of the disclosure is shown. In many embodiments, the process 800 can receive edge data from a plurality of network devices (block 810). For example, a system may have a plurality of camera devices deployed at one or more locations that are configured to track a variety of environments, etc. However, edge data may be received from various storage devices as well.

In a number of embodiments, the process 800 can parse the edge data (block 820). As described above, edge data may be comprised of various data. In certain embodiments, the edge data may be raw, unprocessed data, that, in response to processing, can be parsed into separate video data, metadata, and/or context data. The parsing can be done prior to storage and may be done by one or more devices on the edge of a network deployment.

In more embodiments, the process 800 can input the edge data into a computer vision model (block 830). In some embodiments, inputting edge data, such as video data into a computer vision model involves a series of steps to convert visual information into a format that the model can understand and process. Initially, the video data can be captured or formatted in a frame-by-frame method, with each frame containing visual information. These frames may then be preprocessed to enhance their quality and reduce noise, which may involve techniques such as resizing, normalization, and color space conversion. Next, the frames are fed into the computer vision model(s), either sequentially or in batches, depending on the architecture and requirements of the model. The model can then analyze each frame, extracting features and patterns to make predictions or perform specific tasks, such as object detection, tracking, or action recognition.

In additional embodiments, the process 800 can receive object detection data and tracking data (block 840). In numerous embodiments, the computer vision model(s) can be configured to output object detection data and tracking data associated with the edge data. This data can be formatted to be associated with object detection and tracking of one or more subjects, items, or environments. As those skilled in the art will recognize, the formatting of this data can vary based on the specific deployment or application desired.

In further embodiments, the process 800 can input the object detection data and tracking data into a large language model (block 850). In various embodiments, inputting object detection data and tracking data into a large language model can involve transforming the structured information derived from these tasks into a format compatible with natural language processing. For example, the object detection data, which typically consists of bounding boxes and class labels for detected objects in each frame, needs to be organized into a coherent representation. This may involve encoding the spatial coordinates of the bounding boxes, along with corresponding class labels and confidence scores, into a structured format such as JSON or XML. Similarly, tracking data, which tracks the movement of objects across multiple frames, needs to be processed to capture temporal dependencies and trajectories of objects. This could involve encoding object identities, positions, and velocities over time.

Once the data is structured, it can be fed into a large language model, either as input tokens or as structured inputs alongside textual descriptions or prompts. The model can then analyze the object detection and tracking data, generating textual descriptions, summaries, or responses based on the detected objects and their movements. Additionally, the language model may be fine-tuned on task-specific datasets to improve its ability to understand and generate text based on object detection and tracking data. In some embodiments, the output can be formatted as semantic or contextual data.

In still more embodiments, the process 800 can receive semantic data and contextual data (block 860). As described above, the output of a large language model can be formatted as semantic data and/or contextual data. This data can additionally be formatted in a way that can be processed to make one or more determinations associated with the event(s) within the edge data.

In various embodiments, the process 800 can classify an event at least based on the semantic data and contextual data (block 870). Classification can be in response to the specific application or deployment that is being used. For example, in retail environments, classifications can be related to suspicious or non-suspicious behaviors. In driving related environments, the events can be associated with objects on the roadway or pedestrians near the roadway, etc.

In yet further embodiments, the process 800 can adjust a state based on the event classification (block 880). In some embodiments, the process 800 can exist in one or more states. For example, in the embodiment depicted in FIG. 5, the system exists in either an idle or alert state. However, as those skilled in the art will recognize, the specific states as well as the number of states can vary depending on the type of application or deployment utilized.

Although a specific embodiment for a process for adjusting a state based on an event classification suitable for carrying out the various steps, processes, methods, and operations described herein is discussed with respect to FIG. 8, any of a variety of systems and/or processes may be utilized in accordance with embodiments of the disclosure. For example, the specific types of data that is output from a computer vision model or large language model can vary based on the specific application desired. The elements depicted in FIG. 8 may also be interchangeable with other elements of FIGS. 1-7 and 9-10 as required to realize a particularly desired embodiment.

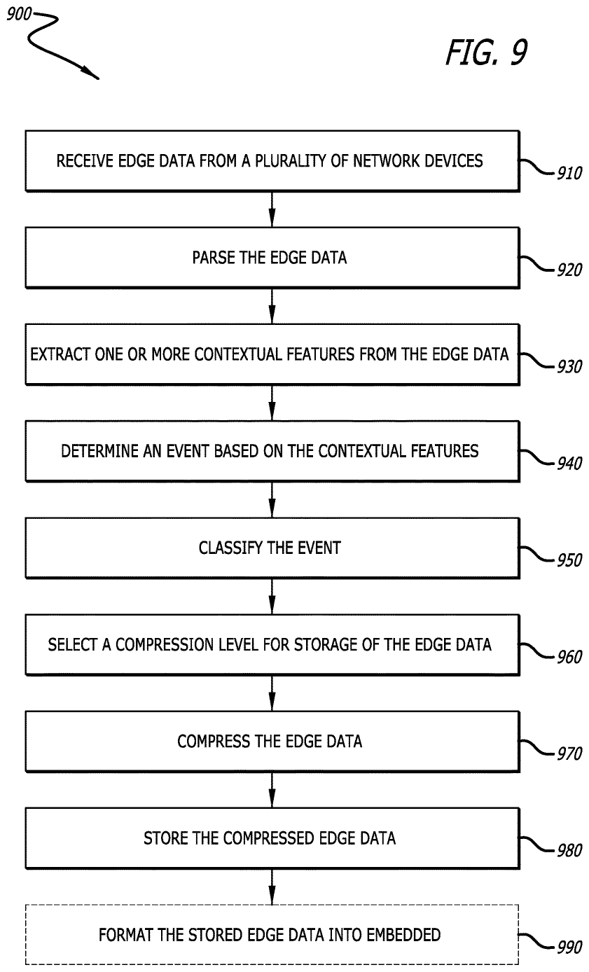

Referring to FIG. 9, a flowchart depicting a process 900 for storing compressed edge data in accordance with various embodiments of the disclosure is shown. In many embodiments, the process 900 can receive edge data from a plurality of network devices (block 910). In some embodiments, the network devices may be IoT devices configured on the edge of a network deployment. For example, a system may have a plurality of camera devices deployed at one or more locations that are configured to track a variety of environments, etc. However, edge data may be received from various storage devices as well.

In a number of embodiments, the process 900 can parse the edge data (block 920). As described above, edge data may be comprised of various data. In certain embodiments, the edge data may be raw, unprocessed data, that, in response to processing, can be parsed into separate video data, metadata, and/or context data. The parsing can be done prior to storage and may be done by one or more devices on the edge of a network deployment.

In more embodiments, the process 900 can extract one or more contextual features from the edge data (block 930). As described above, the output of a computer vision model can be utilized as an input for a large language model. This output can be formatted as semantic data and/or contextual data, which can be utilized to extract contextual features from the edge data. However, as those skilled in the art will recognize, the specific steps to extract contextual features from edge data can vary.

In additional embodiments, the process 900 can determine an event based on the contextual features (block 940). The processing of data can be utilized to select out events that occur within the edge data. The determination can be based on a set of heuristics or may be in response to one or more thresholds being exceeded. For example, an event can be determined if an object crosses into a plane associated with another object, or if movement of a certain speed occurs, etc. Those skilled in the art will recognize that a variety of events can occur that allow for the determination that an event is occurring and should be processed further.

In further embodiments, the process 900 can classify the event (block 950). Classification can be in response to the specific application or deployment that is being used. For example, in retail environments, classifications can be related to suspicious or non-suspicious behaviors. In driving related environments, the events can be associated with objects on the roadway or pedestrians near the roadway, etc.

In still more embodiments, the process 900 can select a compression level for storage of the edge data (block 960). Based on the classification, an event may be deemed as important or non-important. For example, such as in the embodiment depicted in FIG. 5, the system can exist in an idle or alert state. Events associated with an idle state may be configured with a higher compression level compared to events associated with an alert state. In this way, events that may be considered more important can have less compression applied to their associated edge data, which can allow for greater review later. Likewise, by marking one or more events as unimportant and subject to a higher compression rate, the amount of data that needs to be stored and/or sent back to a centralized server is reduced, improving the efficiency of the overall system and process 900.

In various embodiments, the process 900 can compress the edge data (block 970). As those skilled in the art will recognize, the type of compression utilized can vary greatly. For example, for video data, the image data can be compressed using one or more video compression algorithms. The metadata or contextual data may also be compressed using some text or basic data compression methods. The amount of compression utilized can vary based on the type of data being compressed or in response to one or more user, administrator, or logic settings.

In yet further embodiments, the process 900 can store the compressed edge data (block 980). The compressed data can be stored within a local storage device. However, in some embodiments, the compressed data can be transferred to a centralized server or storage device for further processing or storage.

In certain optional embodiments, the process 900 can format the stored edge data into embedded data (block 990). In certain embodiments, edge data can be converted to embedded data by transforming the raw visual information captured in the edge data into a condensed, numerical representation known as embeddings. Initially, the edge data is typically segmented into individual video frames, and each frame is processed using techniques such as convolutional neural networks (CNNs) or recurrent neural networks (RNNs) to extract high-level features. These features capture spatial and temporal patterns within the video frames, encoding information about objects, scenes, and motion dynamics. Subsequently, these extracted features are transformed into dense, fixed-length vectors known as embeddings using methods like dimensionality reduction or learned representations. These embeddings effectively summarize the essential information contained within the video data in a compact numerical format, facilitating efficient storage, analysis, and comparison.

Although a specific embodiment for a process for storing compressed edge data suitable for carrying out the various steps, processes, methods, and operations described herein is discussed with respect to FIG. 9, any of a variety of systems and/or processes may be utilized in accordance with embodiments of the disclosure. For example, the specific steps of compression, storage, and embedding can vary in order based on the specific application. The elements depicted in FIG. 9 may also be interchangeable with other elements of FIGS. 1-8 and 10 as required to realize a particularly desired embodiment.

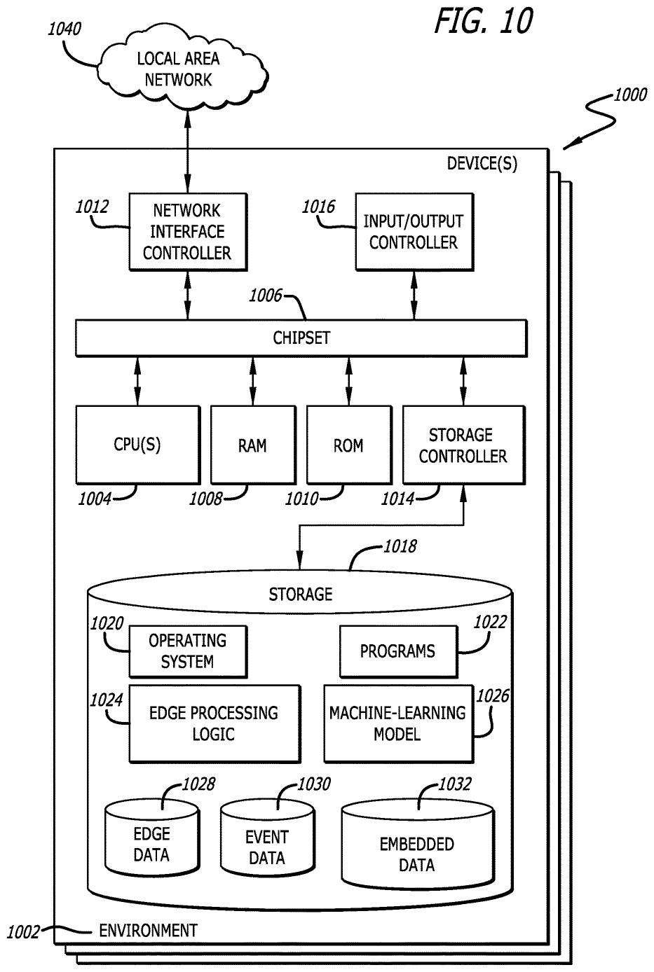

Referring to FIG. 10, a device suitable for utilizing an edge processing logic 1024 in accordance with various embodiments of the disclosure is shown. The embodiment of the conceptual block diagram depicted in FIG. 10 can illustrate a conventional network device, such as, but not limited to, a server, switch, wireless LAN controller, access point, computer, workstation, desktop computer, laptop, tablet, network appliance, e-reader, smartphone, camera, or other IoT computing device, and can be utilized to execute any of the application and/or logic components presented herein. The device 1000 may, in many non-limiting examples, correspond to physical devices or to virtual resources described herein.

In many embodiments, the device 1000 may include an environment 1002 such as a baseboard or “motherboard,” in physical embodiments that can be configured as a printed circuit board with a multitude of components or devices connected by way of a system bus or other electrical communication paths. Conceptually, in virtualized embodiments, the environment 1002 may be a virtual environment that encompasses and executes the remaining components and resources of the device 1000. In more embodiments, one or more processors 1004, such as, but not limited to, central processing units (“CPUs”) can be configured to operate in conjunction with a chipset 1006. The processor(s) 1004 can be standard programmable CPUs that perform arithmetic and logical operations necessary for the operation of the device 1000.

In a number of embodiments, the processor(s) 1004 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 1006 may provide an interface between the processor(s) 1004 and the remainder of the components and devices within the environment 1002. The chipset 1006 can provide an interface to a random-access memory (“RAM”) 1008, which can be used as the main memory in the device 1000 in some embodiments. The chipset 1006 can further be configured to provide an interface to a computer-readable storage medium such as a read-only memory (“ROM”) 1010 or non-volatile RAM (“NVRAM”) for storing basic routines that can help with various tasks such as, but not limited to, starting up the device 1000 and/or transferring information between the various components and devices. The ROM 1010 or NVRAM can also store other application components necessary for the operation of the device 1000 in accordance with various embodiments described herein.

Additional embodiments of the device 1000 can be configured to operate in a networked environment using logical connections to remote computing devices and computer systems through a network, such as the network 1040. The chipset 1006 can include functionality for providing network connectivity through a network interface card (“NIC”) 1012, which may comprise a gigabit Ethernet adapter or similar component. The NIC 1012 can be capable of connecting the device 1000 to other devices over the network 1040. It is contemplated that multiple NICs 1012 may be present in the device 1000, connecting the device to other types of networks and remote systems.

In further embodiments, the device 1000 can be connected to a storage 1018 that provides non-volatile storage for data accessible by the device 1000. The storage 1018 can, for instance, store an operating system 1020, applications 1022. The storage 1018 can be connected to the environment 1002 through a storage controller 1014 connected to the chipset 1006. In certain embodiments, the storage 1018 can consist of one or more physical storage units. The storage controller 1014 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 1000 can store data within the storage 1018 by transforming the physical state of the physical storage units to reflect the information being stored. The specific transformation of physical state can depend on various factors. Examples of such factors can include, but are not limited to, the technology used to implement the physical storage units, whether the storage 1018 is characterized as primary or secondary storage, and the like.

In many more embodiments, the device 1000 can store information within the storage 1018 by issuing instructions through the storage controller 1014 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 1000 can further read or access information from the storage 1018 by detecting the physical states or characteristics of one or more particular locations within the physical storage units.

In addition to the storage 1018 described above, the device 1000 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 1000. In some examples, the operations performed by a cloud computing network, and or any components included therein, may be supported by one or more devices similar to device 1000. Stated otherwise, some or all of the operations performed by the cloud computing network, and or any components included therein, may be performed by one or more devices 1000 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 1018 can store an operating system 1020 utilized to control the operation of the device 1000. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 1018 can store other system or application programs and data utilized by the device 1000.

In many additional embodiments, the storage 1018 or other computer-readable storage media is encoded with computer-executable instructions which, when loaded into the device 1000, may transform it from a general-purpose computing system into a special-purpose computer capable of implementing the embodiments described herein. These computer-executable instructions may be stored as application 1022 and transform the device 1000 by specifying how the processor(s) 1004 can transition between states, as described above. In some embodiments, the device 1000 has access to computer-readable storage media storing computer-executable instructions which, when executed by the device 1000, perform the various processes described above with regard to FIGS. 1-8. In certain embodiments, the device 1000 can also include computer-readable storage media having instructions stored thereupon for performing any of the other computer-implemented operations described herein.

In many further embodiments, the device 1000 may include an edge processing logic 1024. The edge processing logic 1024 can be configured to perform one or more of the various steps, processes, operations, and/or other methods that are described above. Often, the edge processing logic 1024 can be a set of instructions stored within a non-volatile memory that, when executed by the controller(s)/processor(s) 1004 can carry out these steps, etc. In some embodiments, the edge processing logic 1024 may be a client application that resides on a network-connected device, such as, but not limited to, a server, switch, personal or mobile computing device in a single or distributed arrangement.

In some embodiments, edge data 1028 can be captured by devices such as cameras in a network refers to the information gathered at the periphery or “edge” of the network, typically at the point where data is generated or collected. This data is often unprocessed or minimally processed and can encompass a wide range of information depending on the specific application and context. In the case of cameras, edge data may consist of raw pixel values representing images or video frames captured by the camera sensor. These images or frames contain visual information about the environment or scene being monitored, including objects, people, motion, and other relevant details.

Beyond raw pixel data, edge data from cameras may also include metadata providing additional context or information about the captured images or video. This metadata can vary depending on the capabilities of the camera and the configuration of the system but commonly includes timestamps indicating when the data was captured, geolocation data specifying the location where the data was collected, camera settings such as exposure and focus parameters, and any other relevant sensor readings such as temperature or humidity.

Furthermore, edge data may encompass derived features or preprocessed information extracted from the raw data at the edge device itself. For example, edge devices equipped with onboard processing capabilities may perform tasks such as object detection, motion tracking, or image enhancement directly on the captured data, generating intermediate representations or higher-level features that are more compact and informative than the raw pixel data. These derived features can significantly reduce the amount of data that needs to be transmitted over the network and enable more efficient and scalable processing and analysis.

In various embodiments, event data 1030 can comprise information relating to specific events that are captured by the edge data 1028. Event data 1030 can be formatted into various textual structures including, but not limited to, text, or states associated with one or more systems, etc. Event data 1030 can be related to events that are currently being observed/processed or may be stored events related to the past. Other aspects of event data 1030

In a number of embodiments, embedded data 1032 may comprise the data stored by devices such as cameras in a network, embedded data 1032 may be configured as a condensed, numerical representation of the raw sensor readings or processed information, typically derived through techniques like dimensionality reduction or learned representations. This embedded data 1032 captures essential features and patterns within the original data, enabling efficient storage, transmission, and analysis while preserving the critical information necessary for downstream tasks. For example, in the case of video data, embedded representations summarize spatial and temporal features extracted from individual frames, facilitating tasks such as classification, similarity retrieval, and content-based recommendation systems. By transforming raw data into compact embeddings, edge devices can optimize resource usage and enable more scalable and interpretable analysis of the captured information, driving advancements in various applications such as surveillance, smart cities, and industrial monitoring.

In still further embodiments, the device 1000 can also include one or more input/output controllers 1016 for receiving and processing input from a number of input devices, such as a keyboard, a mouse, a touchpad, a touch screen, an electronic stylus, or other type of input device. Similarly, an input/output controller 1016 can be configured to provide output to a display, such as a computer monitor, a flat panel display, a digital projector, a printer, or other type of output device. Those skilled in the art will recognize that the device 1000 might not include all of the components shown in FIG. 10 and can include other components that are not explicitly shown in FIG. 10 or might utilize an architecture completely different than that shown in FIG. 10.

As described above, the device 1000 may support a virtualization layer, such as one or more virtual resources executing on the device 1000. In some examples, the virtualization layer may be supported by a hypervisor that provides one or more virtual machines running on the device 1000 to perform functions described herein. The virtualization layer may generally support a virtual resource that performs at least a portion of the techniques described herein.

Finally, in numerous additional embodiments, data may be processed into a format usable by a machine-learning model 1026 (e.g., feature vectors), and or other pre-processing techniques. The machine-learning (“ML”) model 1026 may be any type of ML model, such as supervised models, reinforcement models, and/or unsupervised models. The ML model 1026 may include one or more of linear regression models, logistic regression models, decision trees, Naïve Bayes models, neural networks, k-means cluster models, random forest models, and/or other types of ML models 1026.

The ML model(s) 1026 can be configured to generate inferences to make predictions or draw conclusions from data. An inference can be considered the output of a process of applying a model to new data. This can occur by learning from at least the edge data 1028, the event data 1030, and embedded data 1032. These predictions are based on patterns and relationships discovered within the data. To generate an inference, the trained model can take input data and produce a prediction or a decision. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 1026 may be generated by human/administrator verifications or may compare predicted outcomes with actual outcomes.

ML model(s) 1026 can, in many embodiments, be a computer vision model or a large language model. A computer vision model is often a computational framework designed to interpret and understand visual information, typically in the form of images or video data. These models employ algorithms and techniques to process visual input, extract meaningful features, and perform tasks such as object detection, image classification, and scene understanding. They are trained on large datasets to learn patterns and relationships within the visual data, enabling them to make accurate predictions and inferences about the content of images or videos. On the other hand, a large language model is a type of artificial intelligence model trained to understand and generate human-like text. These models utilize deep learning architectures, such as transformers, to process and generate natural language based on the context provided in input text. They can perform tasks such as language translation, text summarization, and conversational dialogue generation, and they are trained on extensive textual corpora to develop a broad understanding of language semantics and syntax. Both computer vision and large language models represent powerful tools for processing and understanding different modalities of data, enabling a wide range of applications across various domains.

Unsupervised learning techniques are valuable when labeled data is scarce or unavailable. Clustering algorithms, such as k-means clustering or hierarchical clustering, can group similar traffic flows together based on their feature representations. These clusters can then be analyzed to identify different types of traffic or anomalous behavior within the network. Unsupervised learning provides a data-driven approach to traffic classification, allowing network administrators to discover hidden patterns and structures within the traffic data.

Deep learning models, including convolutional neural networks (CNNs) and recurrent neural networks (RNNs), have demonstrated impressive performance in traffic classification tasks. CNNs can automatically learn hierarchical representations of traffic features, while RNNs can capture temporal dependencies in sequential data, such as packet traces or session logs. These deep learning architectures excel at handling complex, high-dimensional traffic data and can adaptively learn from large-scale datasets to improve classification accuracy.

In certain embodiments the ML models(s) 1026 can be combined into multiple ML models 1026 to enhance classification performance. By aggregating predictions from diverse classifiers or feature subsets, ensemble methods can mitigate the limitations of individual models and improve generalization across different traffic scenarios. These can provide a robust and scalable approach to traffic classification, particularly in dynamic network environments where event patterns evolve over time.

Although a specific embodiment for a device suitable for utilizing an edge processing logic suitable for carrying out the various steps, processes, methods, and operations described herein is discussed with respect to FIG. 10, any of a variety of systems and/or processes may be utilized in accordance with embodiments of the disclosure. For example, the device 1000 may be in a virtual environment, or it may be distributed across a variety of network devices. The elements depicted in FIG. 10 may also be interchangeable with other elements of FIGS. 1-9 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A device, comprising:
a processor;
a network interface controller configured to provide access to a network; and
a memory communicatively coupled to the processor, wherein the memory comprises an edge processing logic that is configured to:
receive edge data from a plurality of network devices;
process the edge data;
extract one or more contextual features from the edge data;
detect at least one behavior based on the one or more contextual features; and
generate an alert based on the at least one behavior.

2. The device of claim 1, wherein the at least one behavior is suspicious behavior.

3. The device of claim 1, wherein the plurality of network devices comprises at least a network-connected video camera.

4. The device of claim 3, wherein the edge data comprises at least video data.

5. The device of claim 4, wherein the edge data comprises at least metadata.

6. The device of claim 5, wherein processing the edge data comprises at least inputting the edge data into one or more machine learning processes.

7. The device of claim 6, wherein the one or more machine learning processes comprises at least a computer vision model.

8. The device of claim 7, wherein an output of the computer vision model is utilized as an input on a large language model.

9. The device of claim 8, wherein the output of the large language model is utilized to extract the one or more contextual features.

10. The device of claim 1, wherein the edge processing logic is further configured to change a state of a system based on the one or more detected behaviors.

11. The device of claim 10, wherein the alert is generated based on the change in state of the system.

12. The device of claim 1, wherein the device exists within a networked system of devices comprising centralized devices and edge devices.

13. The device of claim 12, wherein the device is an edge device.

14. The device of claim 13, wherein the edge processing logic is further configured to store the processed edge data.

15. The device of claim 14, wherein the edge processing logic is further configured to compress the processed edge data prior to storage.

16. The device of claim 15, wherein storing the processed edge data comprises transmitting the processed edge data to a centralized device.

17. The device of claim 16, wherein compression of the processed edge data is based on the at least one detected behavior.

18. A device, comprising:
a processor;
a network interface controller configured to provide access to a network; and
a memory communicatively coupled to the processor, wherein the memory comprises an edge processing logic that is configured to:
receive edge data from a plurality of network devices;
process the edge data;
extract one or more contextual features from the edge data;
detect at least one behavior based on the one or more contextual features;
compress the processed edge data based on the at least one behavior; and
store the processed edge data;
wherein the device exists within a networked system of devices comprising centralized devices and edge devices; and
the device is an edge device.

19. The device of claim 18, wherein the processed edge data is stored on a centralized device.

20. A method, comprising:
receiving edge data from a plurality of network devices;
processing the edge data;
extracting one or more contextual features from the edge data;
detecting at least one behavior based on the one or more contextual features;
compressing the processed edge data based on the at least one behavior; and
storing the processed edge data.
